(19) United States
(12) Patent Application Publication
(10) Pub. No.: US 2019/0050884 A1
(43) Pub. Date: Feb. 14, 2019

(54) DISTRIBUTING SUCCESS-LINKED REWARDS TO CUSTOMERS OF PRIVATELY HELD COMPANIES

(71) Applicant: Bumped, Inc.

(72) Inventor: David Nelsen, Lake Oswego, OR (US)

(21) Appl. No.: 16/101,363

(22) Filed: Aug. 10, 2018

Related U.S. Application Data
(60) Provisional application No. 62/697,284, filed on Jul. 12, 2018.
(60) Provisional application No. 62/543,884, filed on Aug. 10, 2017.

(51) Int. Cl. G06Q 30/02; G06Q 20/06; H04L 9/06

(52) U.S. Cl. CPC G06Q 30/0216; H04L 9/0637; G06Q 20/065; G06Q 30/0232

(57) ABSTRACT

The present disclosure describes examples of systems and methods for enabling a privately held company to establish and provide success-linked rewards to users, through a loyalty platform, based on tracked user loyalty purchases. Success-linked rewards may comprise crypto assets with a built-in deflation mechanism, where the deflation mechanism operates in proportion to one or more metrics associated with the privately held business, or class of privately held businesses, with which the crypto asset is associated.

### CROSS REFERENCE TO RELATED APPLICATIONS

The present application claims priority to U.S. Provisional Patent Application No. 62/697,284, entitled “DISTRIBUTING SUCCESS-LINKED REWARDS TO CUSTOMERS OF PRIVATELY HELD COMPANIES,” filed on Jul. 12, 2018, and U.S. Provisional Patent Application No. 62/543,884, entitled “DETERMINING EQUITY REWARDS BASED UPON PURCHASE BEHAVIOR”, filed on Aug. 10, 2017. The entire contents of each of the above-identified applications are hereby incorporated by reference for all purposes.

### FIELD

The present application relates to systems and methods for providing rewards associated with privately held companies to a user based upon purchase behavior of the user.

### BACKGROUND AND SUMMARY

Many different reward systems have been implemented over time in order to incentivize user loyalty to a particular brand or company. Simple programs such as a “buy 10, get one free” punch card at a local coffee shop or delicatessen are time-tested methods used to promote and reward user loyalty. Cash rewards, as well, have been used in the form of mail-in rebates, providing monetary incentives for users considering the purchase of larger, more expensive items such as appliances or motor vehicles. More recently, reward programs may include gift certificates and cash rewards that are offered to promote loyalty to a particular credit card. Furthermore, mileage programs have long been a reward program offered to instill loyalty to particular airlines, or alternatively, a credit card promoted by an airline.

Many conventional rewards programs fail to effectively build user loyalty with a particular company. Often rewards programs rely on an accrual of points by a user in order to redeem some reward. However, points-based systems may present several issues that impede the development of user or user loyalty. Firstly, points that are accrued often come with an expiration date or date when the points must be redeemed by, therefore placing an additional burden on a user to hurriedly redeem points. Points frequently have no real value outside the scope of a rewards program, and as such, mean little to users in the grand scheme of the financial picture of the user. Furthermore, rewards programs often have unrealistic goals requiring many dollars spent and points earned in order to earn a small reward. Thus, a general shortcoming of such rewards programs is that there is no lasting relationship built with each transaction to create mutual alignment of interests between users and the companies that the users patronize.

The inventors herein have developed systems and methods which may at least partially address the above issues. In one example, a method includes: receiving a loyalty selection from a user, the loyalty selection comprising a selection of a privately held company listed in a database of a loyalty platform in order to receive a success-linked crypto asset associated with the selected privately held company; matching a user purchase with the privately held company by correlating details of the user purchase with the database of the loyalty platform using a calibrated purchase tracking module; determining an amount of success-linked crypto assets based on a monetary value of the user purchase, a user transaction history, and one or more reward policies; distributing the amount of success-linked crypto asset to a user account of the user; and displaying the amount of success-linked crypto asset distributed to the user account.

In another example, a privately held company may create a rewards program with a loyalty platform, the platform automatically tracking user purchases made at the privately held company, and rewarding the user for making the purchases by allocating an amount of an equity-like asset selected by the privately held company to an account of the user on the loyalty platform. The amount of the asset awarded may be based on the purchase amount, the rules of the rewards program as established by the privately held company, and the user loyalty selections.

In one example, the user may be rewarded with an amount of an asset based on a loyalty selection to the privately held company (e.g., represented by a loyalty level). The asset awarded to the user may increase or decrease in price over time based on the success or revenue of the privately held company (and is herein also referred to as a success-linked asset, or success-linked crypto asset), such that the user may have a vested interest in the success of the privately held company due to the correlation between the success of the company and the price of the user's accrued success-linked asset.

In a further example, the success-linked asset may be a crypto asset with a built in deflation mechanism, wherein the deflation mechanism may cause the monetary value of the asset to correlate with revenue of one or more associated privately held companies. The deflation mechanism of the success-linked crypto asset may include a buy-back-and-burn mechanism, wherein a portion of each eligible purchase made at the privately held company goes to buy back a portion of the total supply of the crypto asset, and then burn this portion (immutably remove this portion of the crypto asset from circulation), thereby reducing the total supply and increasing the value of the remaining crypto asset. In another example, the deflation mechanism may include a commodity or security backing process, wherein a portion of each eligible purchase made at the privately held company is used to buy a commodity or security for which the success-linked crypto asset represents ownership. Thus, as more eligible purchases are made at the privately held company, the amount of commodity, or security, backing the crypto asset, and for which the crypto asset may be exchanged, may increase. In this way, privately held companies, which are not able to offer stock as a way to build user loyalty, may instead reward users with a success-linked asset that has a value which may increase over time based on the success, or revenue, of said privately held company. In this way, mutual alignment of interests between users and the privately held companies may be established and long term user-company loyalty may be facilitated.

The above summary is provided to introduce a selection of concepts in a simplified form that are further described below in the Detailed Description. This summary is not intended to identify key features or essential features of the subject matter, nor is it intended to be used to limit the scope of the subject matter. Furthermore, the subject matter is not limited to implementations that solve any or all of the disadvantages noted above or in any part of this disclosure.

### BRIEF DESCRIPTION OF THE FIGURES

FIG. 1A shows an example of a computing system.

FIG. 1B shows an example of a loyalty platform.

FIG. 2 shows a flowchart of an example method for fostering increased user loyalty by enabling a privately held company to partner with a loyalty platform to reward users with an asset tied to the value of the privately held company.

FIGS. 3A, 3B, and 3C show flowcharts of example methods for creating merchant or user accounts on a loyalty platform.

FIGS. 3D, 3E, and 3F show flowcharts of example methods for creating a rewards program using a loyalty platform.

FIGS. 4A, 4B, and 4C show flowcharts of example methods for tracking and rewarding purchases made by users registered with a loyalty platform.

FIGS. 5-8 show example graphical user interfaces of the loyalty platform.

FIGS. 9-11 show diagrams illustrating an example process for increasing user demand and loyalty by creating a crypto asset for use in a rewards program.

### DETAILED DESCRIPTION

The following description relates to systems and methods for a loyalty platform which enables privately held companies (PHCs) to reward users with success-linked crypto assets based on tracked purchases and user loyalty selections. The success-linked assets may increase or decrease in value based on the revenue (or other metrics) of the associated PHC, thereby fostering long term user loyalty by enabling the user to build wealth as accrued rewards increase or decrease in value based on the success/revenue of rewarding PHCs.

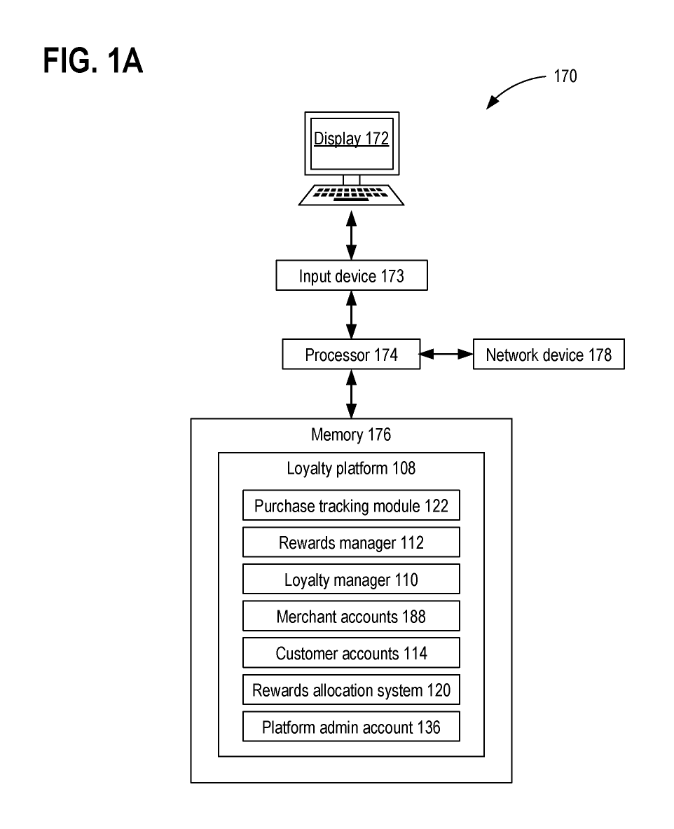

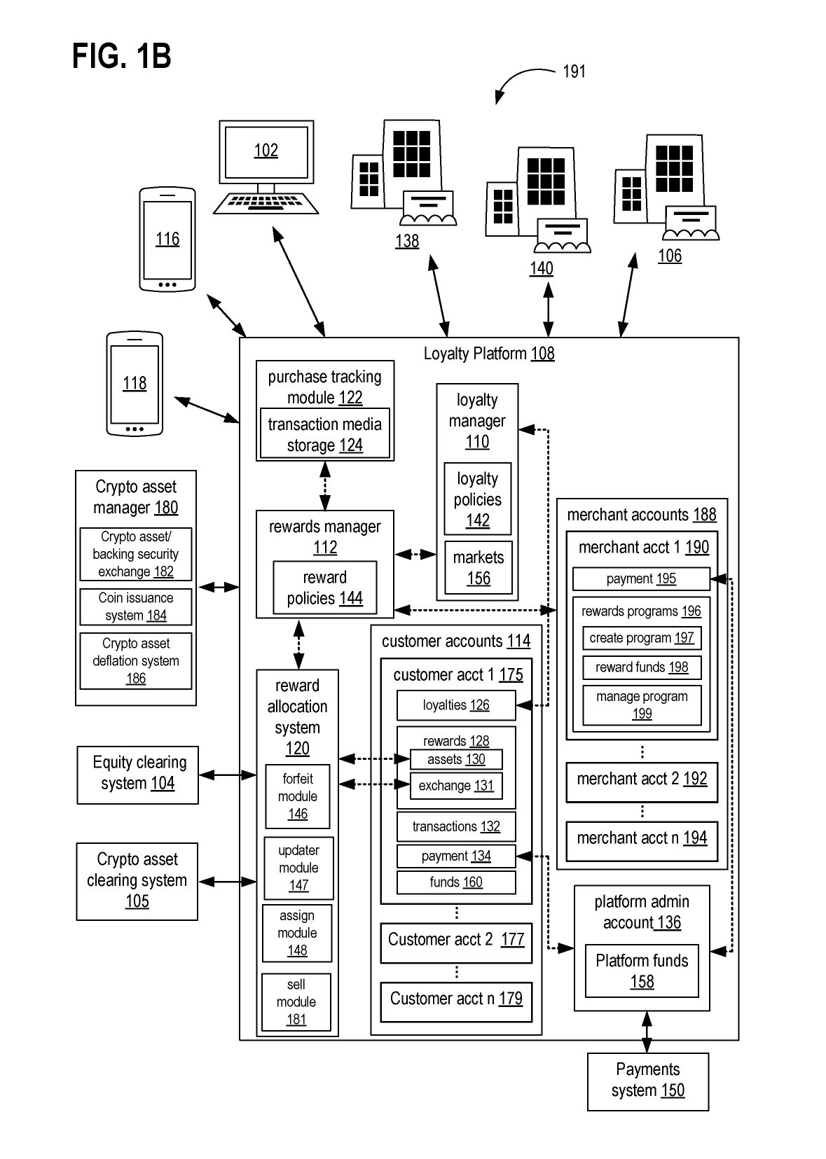

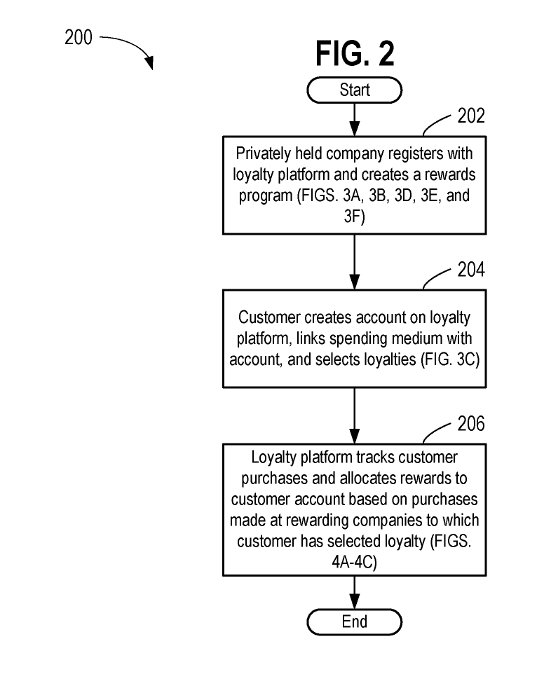

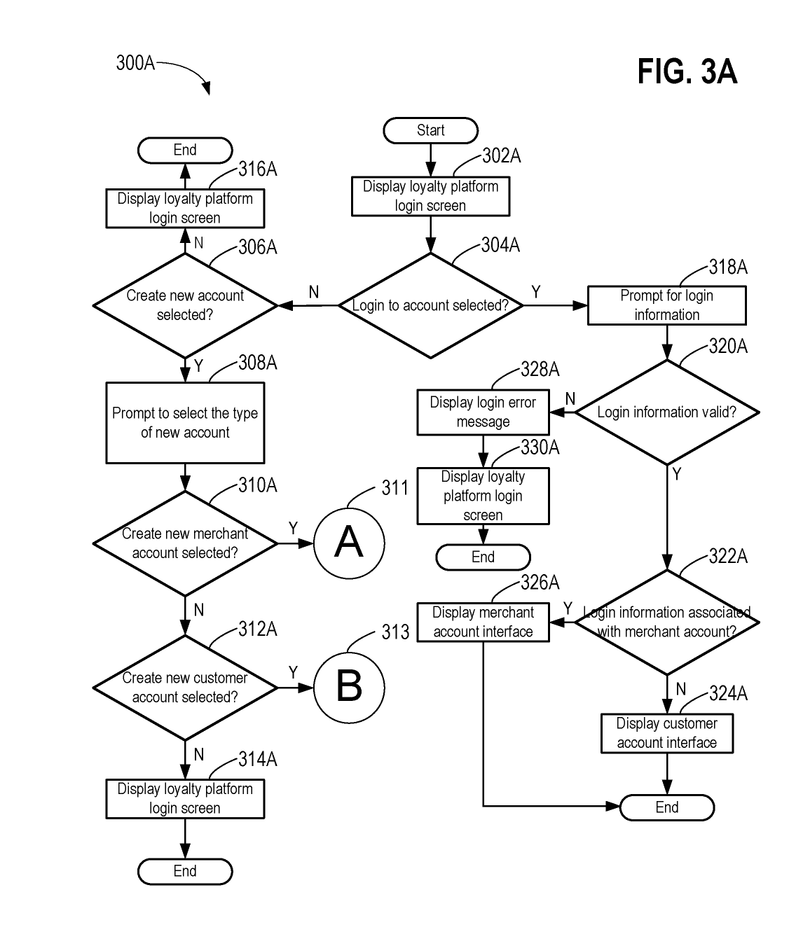

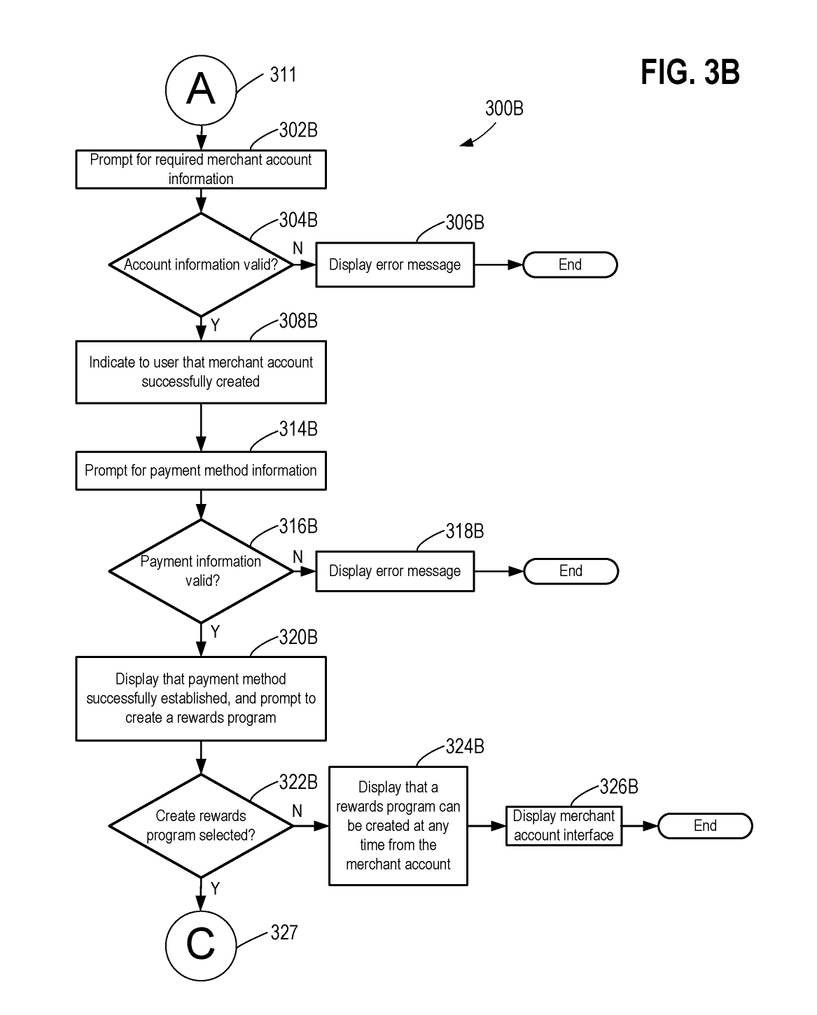

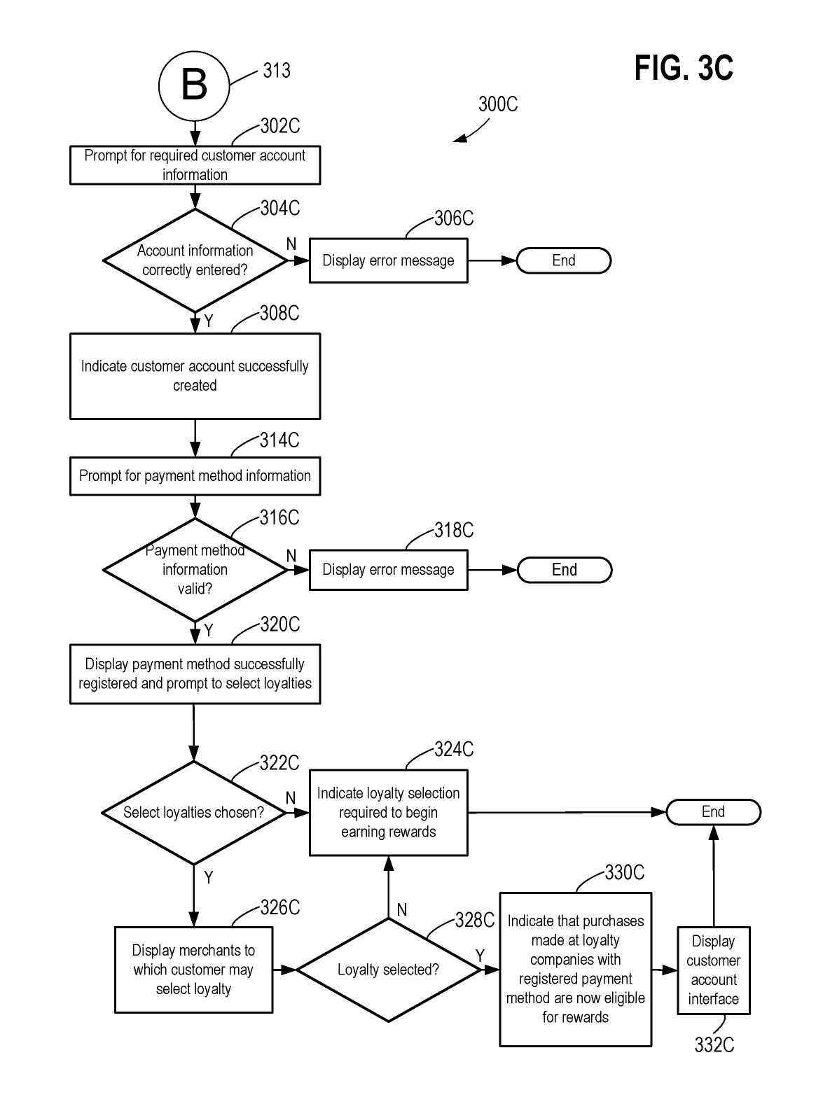

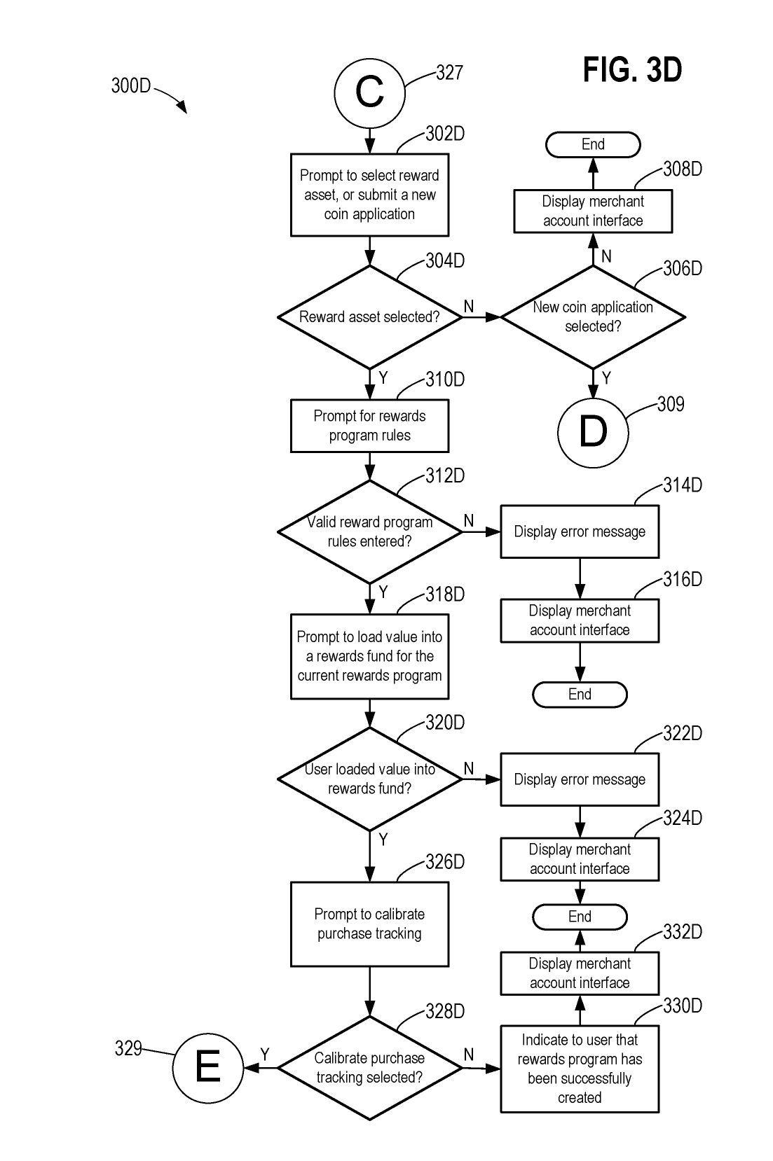

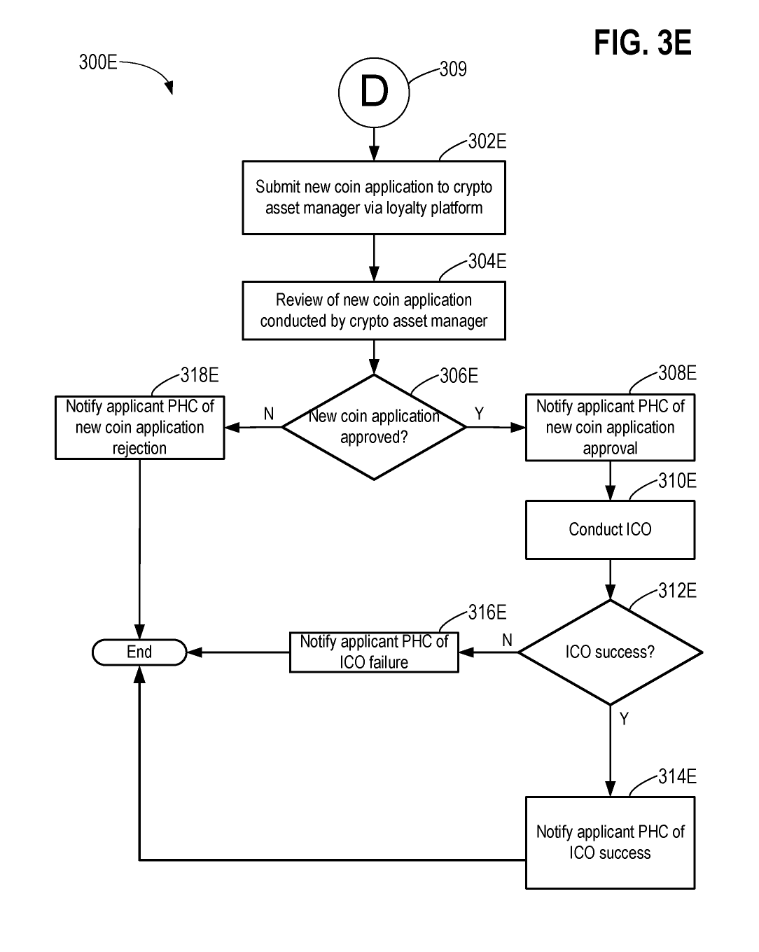

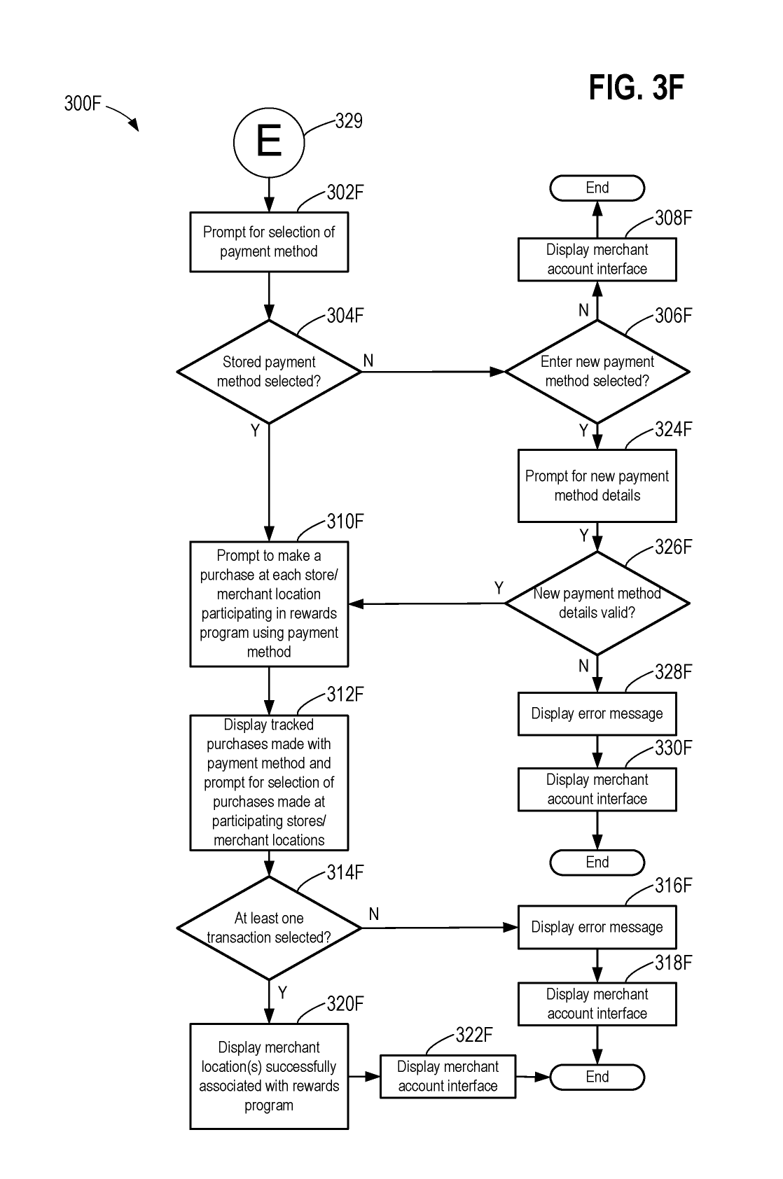

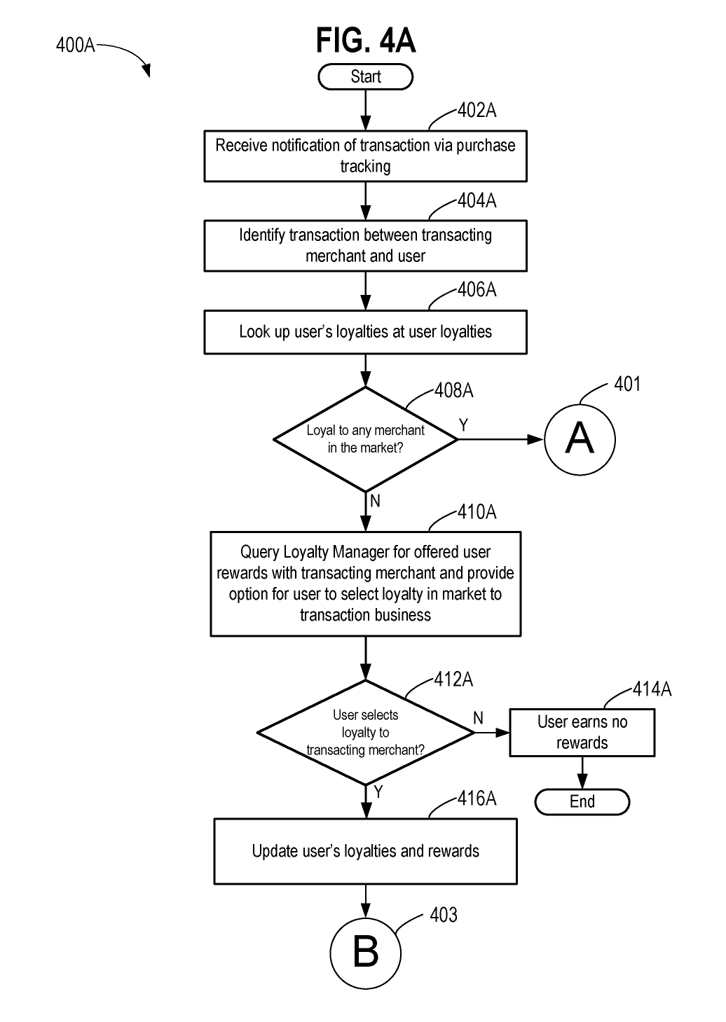

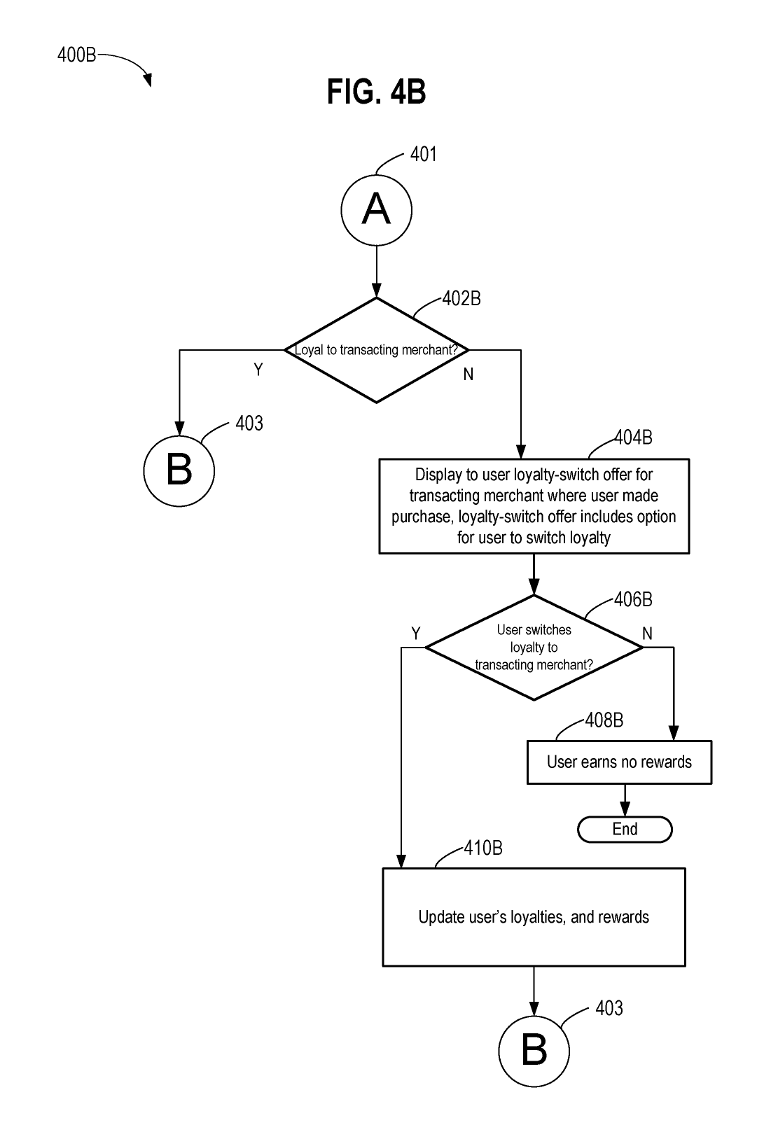

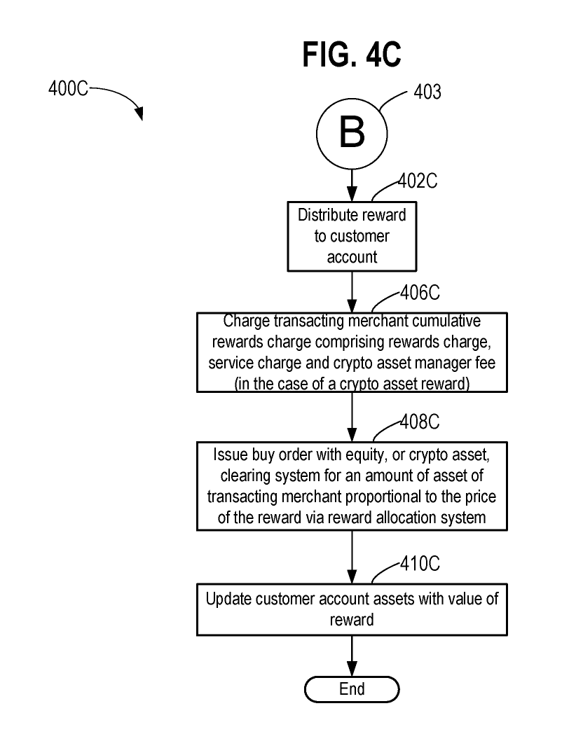

A general shortcoming of conventional rewards programs is a lack of lasting relationship or equity built with each interaction that creates mutual alignment of interests. The user may receive a discount, or possibly aggregate points towards some future reward, but the merchant and the user do not have a symbiotic vested interest in the success of the company. A computing system, an example of which is shown in FIG. 1A, may include memory with instructions stored therein for carrying out the functions of a loyalty platform, such as that shown in FIG. 1B. The loyalty platform may enable PHCs to establish increased long term user loyalty, as well as mutual alignment of interests with its customers, by providing success-linked assets to users as rewards for certain behaviors, such as purchasing goods or services from the PHC. In one example, the success-linked asset rewarded to users of a PHC may include equity in a publicly traded company, or a commodity, the price of which is correlated with the success or revenue of the PHC. In another example, the rewarded success-linked asset may include a cryptocurrency or other crypto asset which may increase in value based on the revenue or success of the PHC, or group of PHCs, with which the crypto asset is associated. FIG. 2 shows a high level flowchart of an example process by which PHCs and users of the PHC may create accounts on a loyalty platform, which enables distribution of the success-linked rewards based on eligible user purchases made at participating PHCs. PHCs may create an account on the loyalty platform, an example of which is shown in more detail in FIGS. 3A and 3B. Once the PHC has created an account on the loyalty platform, said PHC may create an equity rewards program to increase user loyalty. An example method by which a PHC may create a rewards program using the loyalty platform is shown in FIG. 3D. As part of the process of rewards program creation, PHCs may request issuance of a new crypto asset. The value of the success-linked crypto asset may be associated with said PHC (or a class of PHCs) and the success-linked crypto asset may be designed to increase in value based on operation of a deflation mechanism, wherein the deflation mechanism may operate in proportion to the success or revenue of the PHC, thereby coupling PHC success/revenue with the value of the success-linked crypto asset. Success-linked crypto assets may herein be referred to as equity-like rewards, as, similar to shares of stock in a business, success-linked crypto assets may increase or decrease in price based on performance of an associated business. Rewarding users with the success-linked crypto asset may more efficiently align user interests and loyalty with the PHCs providing the rewards. An example of a process by which a PHC may request creation of a success-linked crypto asset is shown in FIG. 3E. Additionally, FIG. 3F shows an example method by which PHCs may increase the accuracy with which eligible purchases made by users are linked with the rewards programs of the PHCs, thereby increasing the efficiency and accuracy of rewards distribution. FIGS. 4A-4C show an example of how the purchase tracking module of the loyalty platform tracks user purchases, links the user purchases to reward programs of rewarding PHCs, and transfers success-linked assets from linked rewards programs to user accounts based on the tracked purchases. In this way, increased user loyalty to PHCs may be enabled via a success-linked asset rewards program operated through a loyalty platform. The methods discussed above, and given in more detail below, may be stored in non-transitory memory of a computing system, and executed by a processor of the computing system. An example of one such computing system is given below.

FIG. 1A shows an example computing system 170, which includes a display 172, an input device 173, a processor 174, memory 176, and network device 178. Memory 176 may comprise any form of memory device known in the art of computers, and may have instructions stored therein, which upon execution by processor 174 carry out one or more steps of the methods herein described. Memory 176 may have instructions store therein which enable one or more functions of a loyalty platform, such as loyalty platform 108. Loyalty platform 108, as described in more detail below, includes a purchase tracking module 122, a rewards manager 112, a loyalty manager 110, merchant accounts 188, user accounts 114, reward allocation system 120, and platform admin account 136. Input device 173 enables a user to interface with computing system 170, and may comprise one or more hardware devices, such as a mouse, keyboard, touch screen, or cameras, which enable a user to input information into a computing system, or manipulate information stored within a computing system. Computing system 170 may further include one or more network devices, such as network device 178 which enable computing system 170 to interact with other electronic devices or computing systems, such as by sending data to, or receiving data from, said other electronic devices. Network device 178 may enable access to a local area network, or may enable connection to the Internet. Computing system 170 may be connected to one or more other computing systems by any method known in the art of computers for sending information between two electronic devices. Display 172 may comprise a monitor, touch screen, projector, or any other device known in the art of computers for enabling a user to observe or sense information.

FIG. 1B schematically shows an example loyalty system 191 that includes a loyalty platform 108, an equity clearing system 104, a crypto asset clearing system 105, a crypto asset manager 180, and a payments system 150. A plurality of users 102, 116, and 118 may register with loyalty platform 108 using user computing devices, wherein the user computing devices may be network-connected devices such as computers and/or mobile phones, and execute transactions (for example, make purchases, trade or sell rewards, etc.). Companies 138, 140, and 106, which may comprise PHCs, may create merchant accounts, such as merchant accounts 188 on the loyalty platform 108, to create rewards programs and incentivize user loyalty thereby. In one example, based upon a loyalty selection (e.g., selecting one business of the plurality of companies 138, 140, 106 in a given market) made by a user (for example, user 102), the user may be entitled to a reward upon conducting a transaction with the selected company.

Equity clearing system 104 may comprise one or more computing devices each including a processor, memory, communication interface, and/or other components. The memory of the computing device(s) of equity clearing system 104 includes instructions or rules for managing a clearing house for assignment of public shares. As a further example, equity clearing system 104 may comprise a clearing house for assignment of non-public shares. Equity clearing system 104 may communicate with reward allocation system 120 of loyalty platform 108 in order to execute transactions such as the buying or selling of shares via the assign module 148 of the reward allocation system 120.

Crypto asset clearing system 105 may comprise one or more computing devices each including a processor, memory, communication interface, and/or other components. The memory of the computing device(s) of crypto asset clearing system 105 includes instructions or rules for managing a clearing house for assignment of crypto assets. As a further example, crypto asset clearing system 105 may comprise a public crypto asset exchange, such as Binance, Gdax, Coinbase, and similar exchanges. Crypto asset clearing system 105 may communicate with reward allocation system 120 of loyalty platform 108 in order to execute transactions such as the buying or selling of crypto assets via the assign module 148 of the reward allocation system 120.

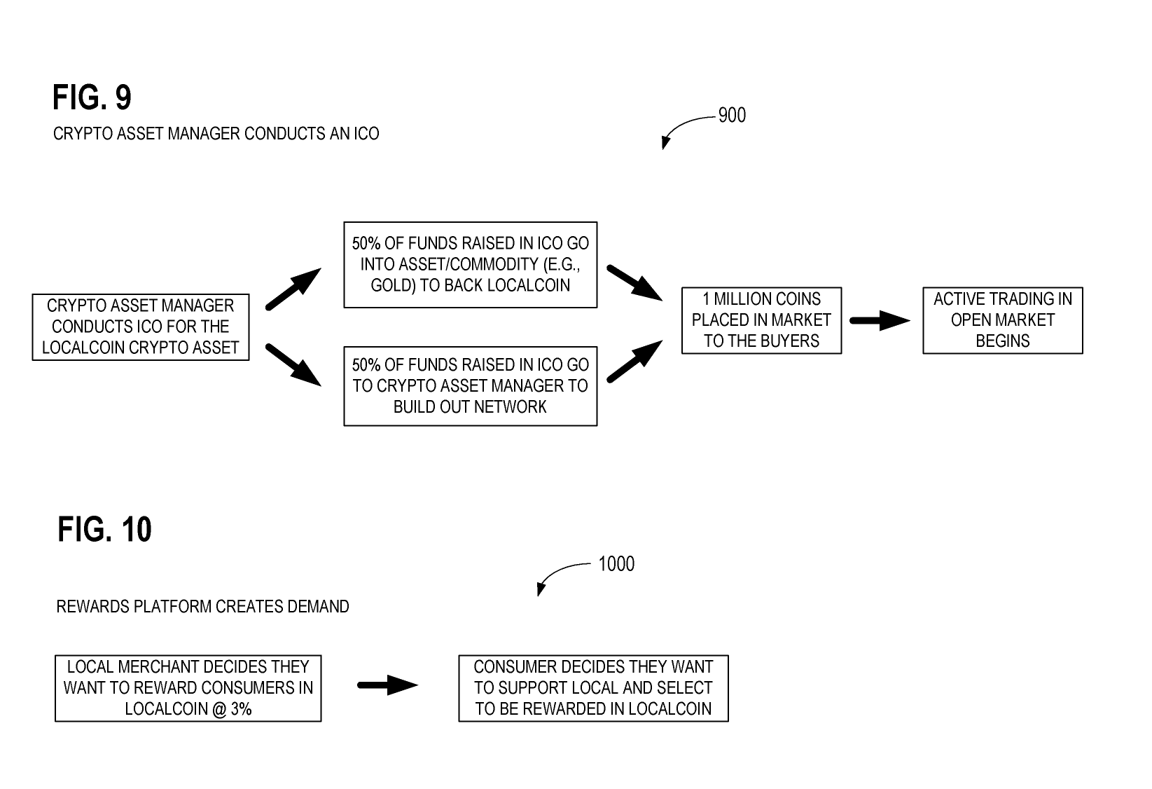

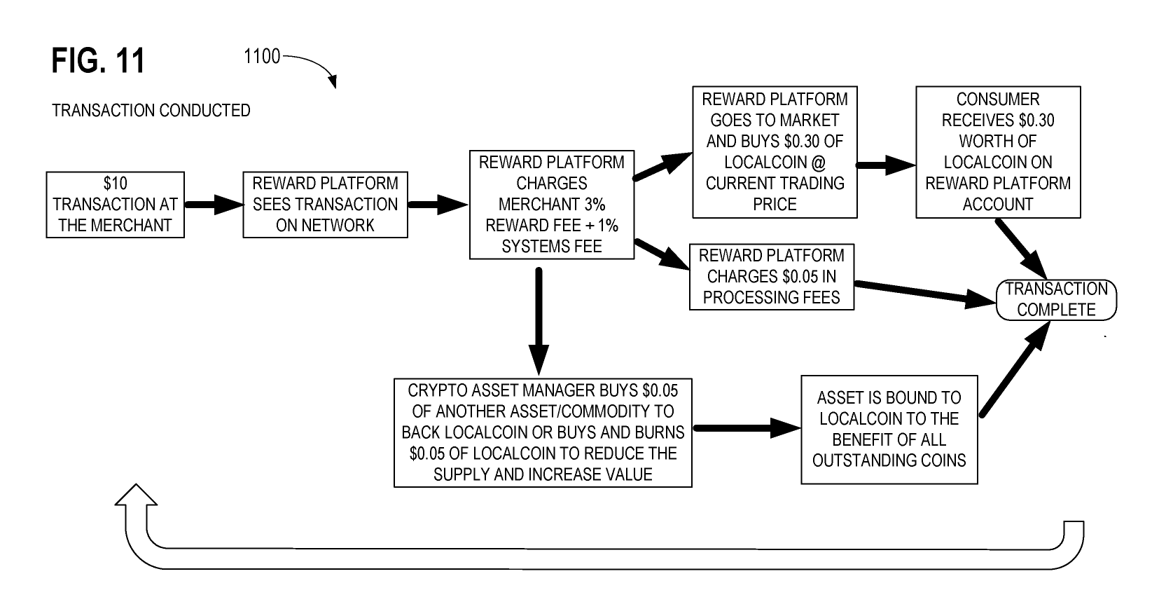

Crypto asset manager 180 may comprise one or more computing devices each including a processor, memory, communication interface, and/or other components. The memory of the computing device(s) of crypto asset manager 180 includes instructions or rules for managing the creation, maintenance, and exchange, of crypto assets created for, or used by, loyalty platform 108. In one example, crypto asset manager 180 includes a coin issuance system 184, which manages PHC requests for new coins, conducts initial coin offerings (ICOs) based upon a successful request (an approved new coin application) for a new coin issuance by a PHC. In another example, crypto asset manager 180 implements crypto asset deflation mechanism 186, which carries out the deflation mechanism built into each crypto asset. In one example, the deflation mechanism of a crypto asset may comprise a process by which the monetary value of a crypto asset is made to correlate with the revenue, productivity, profitability, capital, or other metric of success of the PHC. In an example, a portion of each purchase made at a PHC may be used to purchase an amount of a traditional security which backs the crypto asset, such as using a portion of each sale made at the PHC to buy a quantity of NYSE:GLD (gold) which backs the crypto asset, thereby increasing the monetary value of the crypto asset over time based on the revenue of the PHC, similar to a traditional stock (this is what is herein referred to as an equity-like, or success linked asset). In another example of an equity-like crypto asset, the deflation mechanism may comprise using a portion of eligible revenue or profit from the PHC to buy back and burn (burn in this case meaning to immutably erase or remove from circulation) an amount of the crypto asset, thereby permanently reducing the supply of the crypto asset, and increasing the value of the remaining crypto asset. In another example, crypto asset manager 180 may enable the exchange of crypto assets and the backing securities underlying said crypto assets via a crypto asset/backing security exchange 182. For example, holders of a crypto asset backed by NYSE:GLD may exchange said asset on exchange 182 for an amount of NYSE:GLD, where the amount of the NYSE:GLD depends on the amount of crypto asset exchanged, and on the total pool of NYSE:GLD backing the crypto asset at the time of the exchange. In a more specific example, if 100 units of a security are backing a crypto asset, and a user exchanges 1% of the total supply of said crypto asset using crypto asset/backing security exchange 182, that user will receive 1 unit of the backing security in exchange for the 1% of the total supply of the crypto asset. The 1% of the total supply crypto asset in the previous example will now belong to the crypto asset manager 180. See FIG. 9 and FIG. 11 for additional examples of crypto asset issuance and deflation mechanisms.

Payments system 150 may comprise one or more computing devices each including a processor, memory, communication interface, and/or other components. The memory of the computing device(s) of payments system 150 includes including instructions or rules for disbursing and/or receiving payments via one or more banks, bank accounts, credit card accounts, checking accounts, online payments systems, or virtual wallets. In some examples, payments system 150 may include discrete accounts, each of which may be associated with a user account such as accounts 175, 177, and 179 of user accounts 114, or accounts 190, 192, and 194 of merchant accounts 188, on the loyalty platform 108.

Users 102, 116, 118, in an example, may be associated with user accounts 175, 177, 179. As an example, use of the term “user” or “prospective user” may contemplate any legal entity, whether individual or corporate, which may participate in rewards programs offered by participating PHCs through the loyalty platform 108 by making purchases. Each user may communicate with loyalty platform 108, for example, via a user computing device. Each user computing device may include a processor, memory storing instructions executable by the processor, display, user input devices, and a communication interface.

PHCs 138, 140, 106 may be any merchant, business place, brand, or entrepreneur or entrepreneurial entity associated with loyalty platform 108. As an example, a PHC may comprise any company or merchant or brand (herein the terms company, merchant, business, and brand, are used interchangeably) that does not offer equity for purchase or trading, and may in other words be referred to as non-publicly traded. Each PHC may communicate with loyalty platform 108, for example, via a PHC computing device. Each PHC computing device may include a processor, memory storing instructions executable by the processor, display, input devices, and a communication interface.

Loyalty platform 108 may include a plurality of modules including a loyalty manager 110, rewards manager 112, user accounts 114, merchant accounts 188, reward allocation system 120, purchase tracking module 122, and platform admin account 136. The various modules of the loyalty platform 108 may include instructions stored in one or more storage media that are executable by one or more processors of one or more computing devices. In one example, each module may be stored on memory of and/or executed by a processor of a single computing device. In other examples, the modules may be stored on multiple memories and/or executed by multiple processors distributed across multiple computing devices.

Loyalty platform 108 may further comprise a rewarding-business index (not shown), wherein information relating to PHCs registered with loyalty platform 108 may be stored. As an example, information relating to PHCs stored in the rewarding-business index may include PHC locations (such as GPS coordinates, longitude and latitude, street address, etc.), a PHC description (such as a title), PHC hours of operation, indication of which market(s) the PHC operates in, and other information which may be used to uniquely identify a PHC. In one example, PHC information stored in the rewarding-business index may be used to correlate a user purchase to a specific PHC providing equity-like rewards to users through the loyalty platform, thereby facilitating allocation of an equity-like reward associated with the PHC to the user based on the user purchase, and further based on the user having made a loyalty selection to the identified PHC. In one example, the rewarding-business index may comprise a database, stored on one or more computing systems implementing the loyalty platform.

Loyalty manager 110 administers loyalty policies 142 and updates user loyalties 126 of accounts 114 with updated loyalty policies relating to companies to which a user may select loyalty. Loyalty manager 110 includes loyalty policies 142 and markets 156. Markets 156 may be a database or module which may further represent suitable information regarding categorization of companies affiliated with the system 191 into discrete markets or business segments wherein the companies segmented into different markets compete in some way or offer similar products and/or services. Loyalty manager 110 may represent suitable information regarding loyalty selections of the loyalty platform 108. As a non-limiting example, loyalty manager 110 may include market definitions for a market such as “Groceries (National).” In some examples, companies not affiliated and/or companies pending affiliation or partnership with the platform may be listed in the markets database. In an example, companies listed in the markets database may have different statuses such as “non-partner” (if not partnered with the platform), “partner” (if partnered with the platform), and “pending partner” (if partnership with the platform is pending). Company statuses in the markets 156 may be useful as this may allow users to be made aware of companies which may or may not become platform partners over time, which may factor into a user's decision to select loyalty to a particular business in a market. In one example, a “Groceries (National)” market may include large, nation-wide grocery chains, not limited to, for example, COSTCO, ALBERTSON'S, DOLLAR GENERAL, and KROGER. In another example, a “Coffee shops (Regional)” market may include regional coffee shops and cafes, not limited to, for example, PEET'S COFFEE, SEATTLE'S BEST COFFEE, STUMPTOWN COFFEE ROASTERS, and COURIER COFFEE. In an example, a market may have any number of companies included, and there may be any number of markets included in markets 156. In an example, market definitions may be defined by administrators of the platform admin account 136.

Additionally, loyalty manager 110 may include loyalty policies 142 which may further include instructions or information relating to managing loyalties across markets 156 of loyalty platform 108. Separating companies into individual markets may be a complicated undertaking, as many business and/or merchants exist not only in one market, but are diversified and compete in many different markets. For example, a massive big-box store, such as WALMART sells not only groceries, but also home goods such as electronics, prescription medications, and clothing. As such, loyalty manager 110 may further include loyalty policies 142 that limit the loyalty selections for a user across different markets, so that a user may only select loyalty to a particular business across different markets (of markets 156) a particular number of times. In an example, a user may be allowed to select loyalty to only one business for a single market. In another example, a user may be allowed to select a first loyalty to a business in a first market and to select a second loyalty to the business in a second market. In a further example, a user may be allowed to select loyalty to a business as many times as allowed by loyalty policies 142 across different markets, if the business is “multi-listed” or offered as a loyalty selection across different markets. In a further example, a user may be allowed to select loyalty to one or more companies listed within a market.

Rewards manager 112 may be a module or database and may include reward policies 144 which may further include instructions or information comprising rules for providing and distributing rewards based upon a user's loyalty selection of a transacting merchant (business with which transaction occurs). Additionally, reward policies 144, in an example, may include specific rule sets regarding rewards for a user executing purchases at or with a particular business to which the user has selected loyalty via the loyalty platform. As an example a user's long-term loyalty may be rewarded with increased rewards. In some examples rewards may increase over time. In some examples, rewards may randomly and/or predictably vary over time. In some instances, variable, increasing, and/or long-term loyalty rewards may form stronger user-company relationships and user loyalty. Additionally, if a user switches loyalties from a first company in a first market to a second company in the first market, a promotional, “loyalty-switch offer” may be made available to the user. In an example, a “loyalty-switch offer” may comprise a period of increased rewards per transaction with the business. In an example, a “loyalty-switch offer” might also comprise any of a cash reward, discounted purchases, a set amount of equity or crypto asset, or any other loyalty-switch promotion desired by the administrators of the loyalty platform. As a further example, platform admin account 136 may modify reward policies 144 of rewards manager 112.

User accounts 114 may be a module or database including instructions, information, and/or rules relating to personal and loyalty platform 108 information for each user 102, 116, 118 associated with the loyalty platform 108. User accounts 114 may include a plurality of user accounts. As an example, user 102, 116, and 118 may register with loyalty platform 108 via a smartphone, computer, point-of-sale unit at companies 106, 138, 140, or other network-enabled computing device in order to build and create user accounts 175, 177, 179 associated with (as an example) users 102, 116, and 118, respectively, the accounts being stored in user accounts 114. User accounts may include a user account interface associated with said account, offering access to various features or data, relating to the user account. In one example, the user account interface may enable access to features or utilities, such as information regarding each user, including user loyalties 126, user rewards 128 (which further includes the assets 130 assigned to each user, and an exchange 131 wherein each user may trade or sell the accrued/rewarded assets), user transactions 132, which records a history of user transactions and displays rewards granted per eligible transaction, user payments 134 (e.g., payment preferences, methods, or transaction media), and funds 160, each associated with a respective user, such as user 102. As an example, user loyalties 126 may include the companies and/or brands which the user has selected via a loyalty selection for a single business in a defined market. User rewards 128 of a user's account may include a list of assets 130 which the user has accrued through tracked purchases made at PHCs to which the user has selected loyalty, and who had an active rewards program established through the loyalty platform at the time of the tracked transaction. User rewards 128 may further include an exchange 131 through which each user may trade or sell accrued rewards. Said rewards may comprise cryptocurrency or crypto assets which are representative of the rewarding PHC or whose price is linked to the value, profitability, and/or revenue of the rewarding PHC. Rewards may further include a traditional equity of a company closely associated with the rewarding PHC, such that the value of the associated equity may increase as the revenue and/or profitability of the PHC increases. User transactions 132 may include a history of transactions executed by a user tracked by loyalty platform 108 via purchase tracking module 122. User payment 134 may include user preferences for payment or a virtual wallet held by the loyalty platform 108. User funds 160 may include electronic funds stored for a user which may be used for purchases made via the loyalty platform 108 and/or, as an example, user funds 160 may include funds received via dividend payments from equity, or equity-like rewards, held in assets 130. As an example, accounts 114 may be updated continuously, via communication between rewards manager 112, loyalty manager 110, purchase tracking module 122, reward allocation system 120, on a schedule, and/or in response to a trigger in order to keep user account information updated so that a user may be able to receive up-to-date account information. In an example, purchase tracking module 122 may trigger a user account 175 update based upon receiving a notification of a tracked transaction between a user and a PHC, and purchase tracking module 122 may command rewards manager 112 and loyalty manager 110 to update the user account 175. FIG. 3C gives an example of a method by which a user, such as users 102, 116, or 118 may create an account, such as user accounts 175, 177, or 179.

Merchant accounts 188 may be a module or database including instructions, information, and/or rules relating to information for each PHC registered with the loyalty platform 108, such as PHCs 106, 138, 140. Merchant accounts 188 may comprise a plurality of distinct merchant accounts associated with separate PHCs and/or companies. As an example, PHCs 106, 138, and 140 may register with loyalty platform 108 via a smartphone, computer, or other network-enabled computing device in order to build and create merchant accounts 190, 192, and 194 associated with (as an example) PHCs 106, 138, and 140, respectively. Merchant accounts may include a merchant account interface which may enable the associated PHC or user to access one or more features or utilities of the corresponding merchant account, such as information relating to rewards programs (including funds allocated to rewards programs, rewards program rules, etc.), stored payment methods (previously entered payment methods), or may enable submission of a request for issuance of a new crypto asset (via a new coin application), or management of one or more aspects of an existing rewards program. A merchant account interface may comprise a graphical user interface, with fields with which a user may interact using an input device. In one example input devices may include a keyboard, mouse, touchscreen, or other known user input devices. In another example, user interaction with a field may include selecting the field, inputting data into the field, navigating to a new display page by clicking on the field, etc. FIGS. 3A and 3B give an example of a method by which a PHC may create a merchant account on loyalty platform 108. As an example, accounts 188 may include information for each PHC, including payment 195, rewards programs 196, which further includes utilities for creating a new rewards programs, such as create program 197 which enables the PHC to create a new rewards program by following a step by step process and filling in required information, reward funds 198 which tracks and displays the current funds allocated by the PHC for active rewards programs, and manage program 199, which enables the PHC to adjust rewards program rules, or to cancel the rewards program. Merchant accounts, such merchant account 190, enable PHCs registered with loyalty platform 108 to create, fund, implement, control, and terminate, rewards programs which incentivize user loyalty by providing novel rewards, such as crypto currencies or PHC associated equity, which give the user not just an immediate reward, but a reward which grows as user patronized companies succeed.

Reward allocation system 120 may manage assigning, selling, and forfeiting equity as well as updating current crypto asset prices or equity reward prices. Reward allocation system 120 may additionally include forfeit module 146, updater module 147, assign module 148, and sell module 181, which may be a module or database configured with rules and/or instructions in order to execute buy, sell, and/or forfeit orders of fractional or whole equity or crypto assets between loyalty platform 108 and equity clearing system 104 or crypto asset clearing system 105, as well as, in some examples, between user accounts 114 (including user accounts 175, 177, 179) and platform admin account 136.

Purchase tracking module 122 may be a database or module configured to include instructions and rules configured to track virtual and real-world (e.g., in-store) purchases between users 102, 116, 118 and PHCs 138, 140, 106. The purchase tracking module system may further include transaction media storage 124 (e.g., a database) in order to track purchases for user accounts 175, 177, 179 associated with users 102, 116, 118 who may execute transactions using transaction media which have been registered (or linked) and stored at transaction media storage 124. As an example, transaction media stored within transaction media storage 124 may include any applicable payment methods not limited to credit cards, debit cards, and online payment systems (for example, PAYPAL). In an example, transaction media storage 124 may include registration information relating to credit cards used for transactions between users and companies. In another example, transaction media storage 124 may include registration information relating to only payments systems used for transaction between users and companies. In another example, purchase tracking module 122 may receive a notification or indication that a user has executed a transaction (for example, purchase or return).

The loyalty platform 108 may additionally include platform admin account 136 which may comprise an equity account, such as platform funds 158, tied to the loyalty platform 108, and as an example, in some cases the loyalty platform 108 may accumulate shares and/or funds based upon a user's transaction with a business where the transaction is tracked through the platform. In some instances, when a user forfeits shares the loyalty platform 108 may retain the forfeited shares within platform funds 158. Furthermore, platform admin account 136 may provide platform administrators with rights to make any modifications to the loyalty platform—for example, adding or removing companies to the loyalty selections available through loyalty manager 110, modifying rewards options available through rewards manager 112, modifying user accounts 114, merchant accounts 188, and modifying reward allocation system 120.

Loyalty platform 108 may comprise a computing system including one or more computing devices each including a processor and memory. The computing devices may optionally include display(s), user input device(s), communication interface(s), and/or other components.

The processor may include one or more physical devices configured to execute instructions. For example, the processor may be configured to execute instructions that are part of one or more applications, services, programs, routines, libraries, objects, components, data structures, or other logical constructs included in loyalty platform 108.

The memory includes one or more physical devices configured to hold instructions executable by the processor to implement the methods and processes described herein. When such methods and processes are implemented, the state of memory may be transformed—e.g., to hold different data. The terms “module”, “program”, and “system” may be used to describe an aspect of the computing device(s) implemented to perform a particular function. The terms “module”, “program”, and “system” may encompass individual or groups of executable files, data files, libraries, drivers, scripts, database records, etc.

The display may be used to present a visual representation of the loyalty platform 108. This visual representation may take the form of a graphical user interface (GUI). The display may include one or more display devices. User and/or PHC input device(s) may comprise or interface with one or more user-input devices such as a keyboard, mouse, touch screen, and/or game controller. Additionally, the communication interface may be configured to communicatively couple the loyalty platform 108 with one or more other computing devices, such as the payments system 150, equity clearing system 104, crypto asset clearing system 105, crypto asset manager 180, user computing devices, and/or business computing devices. The communication interface may include wired and/or wireless communication devices compatible with one or more different communication protocols. As non-limiting examples, the communication interface may be configured for communication via a wireless telephone network, or a wired or wireless local- or wide-area network. In some embodiments, the communication interface may allow the loyalty platform 108 to send and/or receive messages to and/or from other devices via a network such as the Internet.

Any of the computing devices, modules, or elements described herein with reference to exemplary system 191 of FIG. 1B may communicate with each other via a network. For example, loyalty platform 108 may communicate with equity clearing system 104, crypto asset clearing system 105, crypto asset manager 180, and payments system 150 via a network.

Loyalty platform 108 enables benefits for both PHCs and users by providing a mechanism for PHCs to provide rewards to loyalty users through creation of loyalty based user rewards programs, and for loyalty users to be automatically and efficiently rewarded for eligible purchases made at PHCs to which they are loyal. Loyalty platform 108 enables PHCs to create bespoke rewards programs which cater to that specific PHCs business model and vision. Loyalty platform 108 enables the creation, implementation, and management of a novel rewards program for companies, including PHCs, which in some examples includes creation of custom crypto assets for a PHC, or a group or class of PHCs. The crypto assets may be used as a reward asset given to loyalty users based on tracked purchases, said crypto asset may mimic in some aspects a traditional equity in the PHC, thus enabling PHCs to obtain at least some of the advantages of publicly traded institutions, such as long term user loyalty creation through stake sharing. Additionally, platform 108 provides users the ability to choose loyalties, grow wealth by earning rewards which grow as the companies that user patronizes grows, and sell or trade earned rewards, either amongst other users using loyalty platform 108, or on asset exchanges, such as equity clearing system 104 or crypto asset clearing system 105. A high level flowchart of an example method by which loyalty platform 108 enables these benefits is shown in FIG. 2.

Turning to FIG. 2, a high level flowchart of an example method 200 showing how a loyalty platform, such as loyalty platform 108 of FIG. 1B, enables PHCs and users to participate in a mutually beneficial rewards program. The rewards program may incentivizes long term user loyalty to PHCs, by enabling users of the PHC to accrue equity, or equity-like rewards, from everyday purchases.

Method 200 begins at 202, which includes the PHC registering with the loyalty platform by inputting information into one or more fields of a loyalty platform interface/display. The input information may enable the platform to identify the PHC and determine in which markets said PHC operates (as described in more detail by example flowcharts shown in FIGS. 3A and 3B). Step 202 of method 200 also includes the PHC creating a rewards program which may include defining rewards program rules, specifying an asset to reward users with, and allocating funds to be used to provide said rewards (described in more detail by FIGS. 3D, 3E, and 3F). Method 200 may then proceed to 204.

At 204 method 200 includes creating a user account on the loyalty platform. User account creation may include linking or registering a payment medium/transaction medium with the loyalty platform (such as a credit card, debit card, and/or other payment/transaction medium), thereby enabling the platform to track purchases made by the user and reward the user based on eligible purchases. User account creation my further include user loyalty selection, wherein the user may select amongst PHCs with active rewards programs on the loyalty platform to choose loyalty to, and thereby become eligible to receive rewards based upon purchases made at said PHCs. FIG. 3C, described below, illustrates in more detail an example method for user account creation. Method 200 may then proceed to 206.

At 206, method 200 includes the loyalty platform tracking user purchases made using the registered or linked payment method, and distributing rewards to a user account on the loyalty platform based on eligible purchases made at rewarding companies to which user has selected loyalty (described in more detail with regard to FIGS. 4A-4C). In one example, eligible purchases may include purchases made by users with an active user account on the loyalty platform, the purchase occurring at a PHC or business to which the user has selected loyalty, and said PHC or business having an active rewards program through the loyalty platform (with a positive non-zero rewards program fund balance associated with said active rewards program). In this way, PHCs and users may be advantageously connected through a loyalty platform which enables creation, execution, and management, of a rewards program offering equity, or equity-like, rewards.

Turning now to FIG. 3A, a flowchart for an example method 300A for logging into, or registering with, a loyalty platform is shown.

Method 300A begins at 302A, which includes displaying a loyalty platform login screen to the user (user will herein imply either users or PHCs). In one example, the login screen may be displayed on a display apparatus of a network connected device of the one or more users of the loyalty platform, such as a screen of a smartphone, or a monitor of a computer. The login screen may display to the user instructions for interacting with the login screen, such as where to input login information, and/or how to create a new account on the platform, as well as other information pertinent to the usage of the loyalty platform. In one example, the login screen is a combined login screen for all users regardless of user type (users are either users or companies as defined herein, with companies further including PHCs). In another example, the login screen may be differentiated based on user type, such as a first login screen or interface for users, and a second login screen or interface for companies. The login screen may prompt the user to login to an account, or for first time users, to create a new account. Method 300A may then proceed to 304A.

At 304A method 300A includes the loyalty platform determining if the user has selected to login to an account. If at 304A the loyalty platform determines that the user has selected to login to an account, method 300A may then proceed to 318A. At 318A the loyalty platform may prompt the user to input account information into designated fields on the display/interface. In one example account information includes a username and password uniquely associated with a pre-existing account on the loyalty platform. In another example, the login information includes a signal received from a biometric scanner, such as a fingerprint or retinal scanner, said signal uniquely associated with one or more biometric features previously associated with a pre-existing account on the loyalty platform. Upon user submission of login information, method 300A may then proceed to 320A. At 320A, method 300A includes evaluating if the user input login information is valid. Validation of user login information may include matching a username and password to a pre-existing account on the loyalty platform. In another example login information validation may include assessing if one or more or a combination of user authentication metrics have been passed, or that one or more pieces of biometric data of the current user matches with a selected account or username. If at 320A the loyalty platform determines that the login information was not valid, such as if the login information does not match with any currently existing account, than method 300A may proceed to 328A, whereat a login error message may be displayed on the user display or interface, and which may include one or more pieces of information relating to how/why the login information was not valid. Method 300A may then proceed to 330A, whereat the loyalty platform returns to the platform login screen, such as at 302A. Method 300A may then end.

However, if at 320A the login information was determined to be valid by the loyalty platform, method 300A may proceed to 322A, whereat the login information entered by the user is matched with an existing account, and the loyalty platform determines if that account is a merchant account. If at 322A, the loyalty platform matches the login information with an existing merchant account, method 300A may then proceed to 326A, whereat the loyalty platform will proceed to display the merchant account interface to which the login information corresponds. In one example the merchant account interface may have been previously customized by the user to enable rapid identification and display of one or more pieces of relevant information associated with said merchant account. In another example, the merchant account interface may include one or more features indicated or discussed regarding merchant accounts 188 in FIG. 1B, such as payment, rewards program creation and management, allocation of funds for operation of an existing rewards program, etc. After 326A, method 300A may then end. However, if at 322A the loyalty platform determined that the login information was not associated with a merchant account, method 300A may then proceed to 324A, whereat the user account interface, to which the login information uniquely matched, is displayed. This is because, in this embodiment, user accounts are of two types, and if the account is not a merchant account, the account is a user account. The user account interface may include access to one or more or all of the features shown or discussed in regards to user accounts 114 of FIG. 1B, such as loyalties, assets, trades, transactions, payment, and funds. Method 300A may then end.

However, if at 304A it was determined that the user had not selected to login to account, method 300A may then have proceeded to 306A, where the loyalty platform may have evaluated if the user had selected to create a new account. If at 306A the platform determined that the user had not selected to create a new account, than method 300A would proceed to display the login screen to the user, such as at 302A, and method 300A may then end. However, if at 306A the loyalty platform determined that the user had selected to create a new account, method 300A may then proceed to 308A, whereat the user would be prompted to select the type of the new account. In one example, account types comprise merchant accounts and user accounts. In other examples, account types may also include subsets of these account types, or may include additional account types, such as administrator accounts. Method 300A may then proceed to 310A. At 310A, method 300A includes the loyalty platform evaluating if the user selected to create a new merchant account. If at 310A the loyalty platform determined that the user selected to create a new merchant account, method 300A may then proceed to 311, wherein the merchant account creation method is executed by the loyalty platform as given in more detail by FIG. 3B.

However, if at 310A the loyalty platform determines that the user did not select to create a new merchant account, than the method 300A proceeds to 312A, whereat the user input is evaluated to determine if the user selected to create a new user account. If at 312A, the loyalty platform determines that the user selected to create a new user account, then method 300A may proceed to 313, wherein the user account creation method is executed by the loyalty platform as given in more detail by FIG. 3C. Finally, if at 312A, the loyalty platform determines that the user did not select to create a new user account, method 300A may proceed to 314A, whereat the loyalty platform displays the login screen to the user, as at 302A. Method 300A may then end.

In this way, users of the loyalty platform can login to existing user accounts, or merchant accounts, or can select to create a new user account or merchant account. FIGS. 3B and 3C illustrate an example method for creating new merchant accounts and user accounts.

Turning now to FIG. 3B, an example method 300B is shown. Method 300B gives one example of a method by which a new merchant account may be created on the loyalty platform. By creating a new merchant account, pertinent information required to identify the PHC, and create and implement a rewards program for that PHC, are input into the loyalty platform.

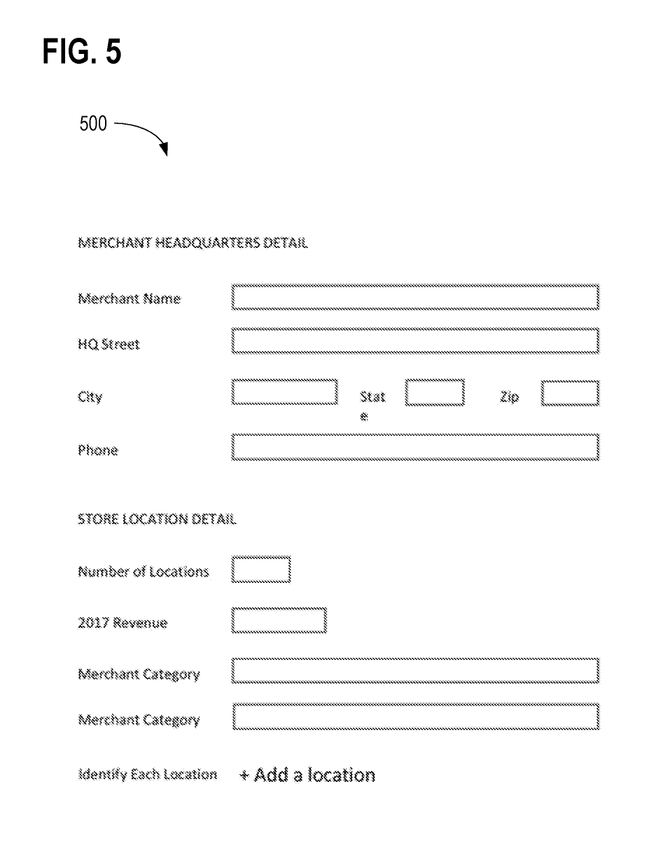

Method 300B begins at 302B, where the loyalty platform prompts the PHC to input merchant account information (such as that shown by FIG. 5) into designated fields on the display/interface using user input devices. In one example merchant account information may include a new account username, a new account password, company name or ID, company address(es)/locations, company contact information, relevant markets in which said companies operates. In one example, merchant account information may be stored in a database, such as the rewarding-business index, and subsequently used to facilitate linking user purchases with registered merchant reward programs. Once the loyalty platform has detected that all required fields have been filled, and that the PHC has selected to proceed, or in some other way received an indication that all required merchant account information has been input, method 300B may then proceed to 304B.

At 304, method 300B includes evaluating the merchant account information for validity. Validity evaluation may include one or more input screening techniques which compares the format of input data with an expected format of input data, or confirms that input account information links to a real and unique companies or location. If the loyalty platform determines that the user input merchant account information is not valid, method 300B may then proceed to 306B, whereat the loyalty platform may display an error message to the user. Said error message may indicate how/why user input failed the validity evaluation, and may make recommendations to the user for correctly inputting said information in a subsequent attempt. Method 300B may then end.

If at 304B, the merchant account information was determined to be valid, method 300B may then proceed to 308B. At 308B method 300B includes indicating to the PHC that merchant account information was successfully entered, and that a new merchant account has successfully been created based on the input data. Method 300B may then proceed to 314B.

At 314B method 300B includes prompting for input of payment method information into designated fields on the display/interface using input devices. In one example payment information may include credit card information, such as a credit card number, expiration date, and pin. In another example, payment information may include a digital wallet address, or account information for a digital payment service (such as PayPal, Venmo etc.). Upon an indication to the loyalty platform that the payment method information has been entered, method 300B may then proceed 316B.

At 316B, method 300B may include evaluating input payment information for validity. Validity evaluation may include one or more input screening techniques which compares the format of input data with an expected format of input data, or confirms that input payment information links to a real and unique payment account, wallet, or service. If the loyalty platform determines that the payment information is not valid, method 300B may then proceed to 318B, whereat the loyalty platform may display an error message to the user. Said error message may indicate how/why input payment method information failed the validity evaluation, and may make one or more recommendations for correctly inputting said information. Method 300B may then end.

If at 316B, the loyalty platform determines that the payment information is valid, method 300B may then proceed to 320B. At 320B, method 300B includes indicating that a payment method was successfully established, and that a rewards program may now be created using said payment method. 320B may then include prompting the PHC to create a new rewards program, wherein the prompt may be displayed via a display of a PHC computing device. Method 300B may then proceed to 322B.

At 322B, method 300B may include evaluating if the PHC has selected to create a new rewards program. If at 322B, the loyalty platform determines that the PHC selected to create a new rewards program, method 300B may proceed to 327B, wherein a method for creating a new rewards program is executed by the loyalty platform, as shown in more detail by FIG. 3D. However, if at 322B the loyalty platform determines that the PHC selected not to create a new rewards program, method 300B may then proceed to 324B, whereat the loyalty platform may indicate to the PHC that a new rewards program may be created anytime through the merchant account interface. From 324B, method 300B may proceed to 326, where the loyalty platform may display the merchant account interface. Method 300B may then end.

In this way, method 300B may enable PHCs using the loyalty platform for the first time, to create a new account with the loyalty platform. This account may further enable creation of a rewards program based at least partially on the information entered during the new merchant account creation. An analogous process may be used by the loyalty platform to create new user accounts, an example of which is illustrated in FIG. 3C.

Turning now to FIG. 3C, an example method 300C for creating a new user account is shown. Method 300C enables new users to register with the loyalty platform and create a new user account, and thereby become eligible to earn equity, or equity-like rewards through everyday purchases.

Method 300C begins at 302C, where the loyalty platform prompts the user to input user account information into designated fields on the display/interface using user input devices. In one example new user account information may include user contact information, username, password, information from identity documents (passport, driver's license etc.), social security number, bank routing number and account number (for direct deposits of funds earned via accrued rewards), and other information known in the art as required or beneficial for new user registration with equity brokers. Once the loyalty platform has detected that all required fields have been filled, and that the user has selected proceed, or that the loyalty platform has in some other way received an indication that all requested new user account information has been input, method 300C may then proceed to 304C.

At 304C, method 300C includes evaluating the user input user account information for validity. Validity evaluation may include one or more input screening techniques which compares the format of input data with an expected format of input data, or confirms that input account information links to a real and unique identity. If the loyalty platform determines that the user input user account information is not valid, method 300C may then proceed to 306C, whereat the loyalty platform may display an error message to the user. Said error message may indicate how/why user input failed the validity evaluation, and may make one or more recommendations to the user for correctly inputting said information in a subsequent attempt. Method 300C may then end.

However, if at 304C, the user input user account information was determined to be valid, method 300C may then proceed to 308C. At 308C method 300C includes indicating to the user that user account information was successfully entered, and that a new user account has successfully been created based on the input data. Method 300C may then proceed to 314C.

At 314C, method 300C includes prompting the user to input payment method information into designated fields on the display/interface using user input devices. Payment information entered by the user is used by the loyalty platform to track purchases made by the user for purposes of loyalty purchase identification and automatic reward allocation, as given in more detail by FIGS. 4A-4C. In one example payment information may include credit card information, such as a credit card number, expiration date, and pin. In another example, payment information may include a digital wallet address, or account information for a digital payment service (such as PayPal, Venmo, etc.). Upon an indication to the loyalty platform that the user has entered information in all of the required fields, method 300C may then proceed 316C.

At 316C, method 300C may include evaluating the user input payment information for validity. Validity evaluation may include one or more input screening techniques which compares the format of input data with an expected format of input data, or confirms that input payment information links to a real and unique payment account, wallet, or service. If the loyalty platform determines that the user input payment information is not valid, method 300C may then proceed to 318C, whereat the loyalty platform may display an error message to the user. Said error message may indicate how/why user input failed the validity evaluation, and may make one or more recommendations to the user for correctly inputting said information in a subsequent attempt. Method 300C may then end.

If at 316C, the loyalty platform determines that the user input payment information is valid, method 300C may then proceed to 320C. At 320C, method 300C includes indicating to the user that the payment medium was successfully linked, and that user loyalties may now be selected. 320C may then include prompting the user to select loyalties. Method 300C may then proceed to 322C.

At 322C, method 300C may include evaluating if the user chose to make loyalty selections. If at 322C, the loyalty platform determines that the user selected not to make loyalty selections, method 300C may proceed to 324C, whereat the loyalty platform indicates via display/interface to the user that loyalty selection is required before rewards may be earned. Method 300C may then end. However, if at 322C the loyalty platform determines that the user chose to select loyalties, method 300C may proceed to 326C.

At 326C, method 300C may include the loyalty platform displaying a list of companies or PHCs with active rewards programs offered through the loyalty platform, to which the user may make a loyalty selection and begin earning rewards. The display/interface may include one or more fields with which the user may interact to indicate which loyalty selections the user wishes to make, such as check boxes, or a drag-and-drop selection process. Upon an indication to proceed generated by the user and received by the loyalty platform, method 300C may then proceed to 328C. A loyalty user of a PHC is herein defined as being a user who has an active loyalty selection to the PHC.

At 328C, method 300C includes the loyalty platform evaluating user input to determine if a loyalty selection to one or more companies was made. If at 328C the loyalty platform determines that no loyalty selections were made, method 300C may proceed to 324C, whereat the loyalty platform indicates via display/interface to the user that loyalty selection is required before rewards may be earned. Method 300C may then end.

If at 328C the loyalty platform determines that one or more loyalty selections have been made by the user, than method 300C may proceed to 330C, whereat the loyalty platform indicates to the user via display/interface that purchases made using linked payment media at PHCs to which the loyalty selection(s) were made, are now eligible for rewards. Method 300C may then proceed to display the user account interface, from which the user may access one or more of the features/utilities indicated by FIG. 1B, such as user accounts 114. Method 300C may then end.

In this way, method 300C enables new users to quickly establish a new account on a loyalty platform which may further enable the user to begin accruing rewards based on purchases made with a linked/registered payment method at PHCs participating in an active rewards program through the loyalty platform.

Turning now to FIG. 3D, an example method 300D by which a PHC may create a new rewards program is shown. Method 300D enables companies to create equity or equity-like rewards programs which drive long term user loyalty and may increase user demand, both in the short and long term.

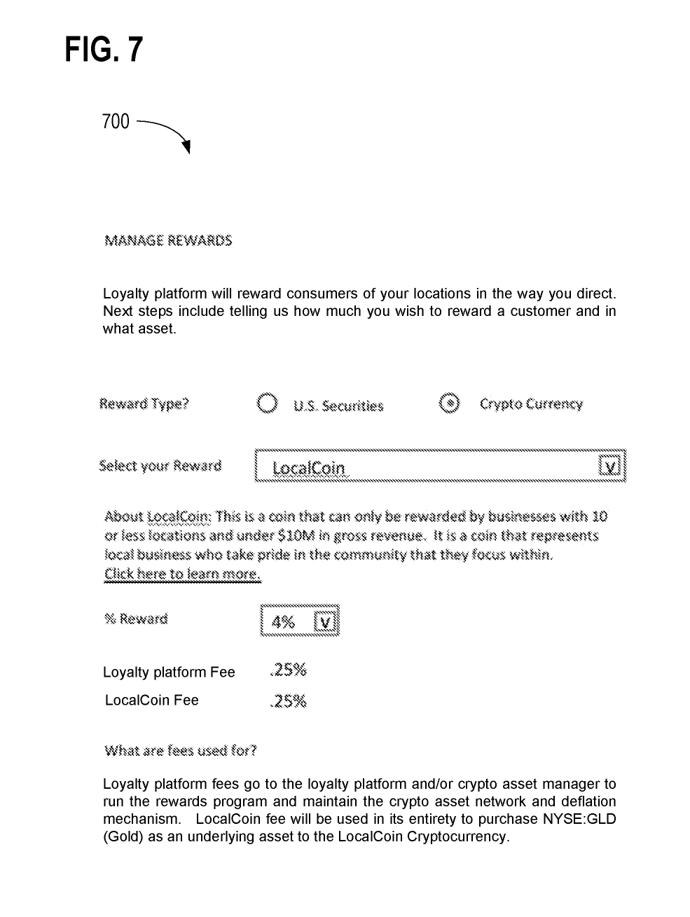

Method 300D begins at 302D, whereat a loyalty platform prompts the PHC to select an asset to use for rewarding user loyalty, or, to submit a new coin application which may lead to issuance of a new crypto asset which may represent the PHC providing said reward. In one example, reward assets are a traditional equity of a publicly traded companies closely associated with the rewarding PHC (non-publicly traded business), such as stock in a coffee roasting company used as a reward to users who make purchases at, and have made a loyalty selection to, a local café (the local café buying a substantial amount of product from the publicly traded coffee roasting company). In another example, a reward asset may be a pre-existing cryptocurrency or crypto asset which is linked with a particular PHC or class/category of PHC, such as, for example, LocalCoin, which may be associated with local grocers (the precise definition of which companies may be associated with LocalCoin may reside within the whitepaper of LocalCoin). In one example, LocalCoin may have a built in and immutable deflation mechanism which links its value with the revenue, profit, capital, or other aspect, of the associated local grocers, and may in this way behave as an analog, or substitute for, traditional equity. In another example, the PHC may decide that none of the existing assets suitably reflect stake in the PHC, and my elect to submit an application containing ideas for a new crypto asset or cryptocurrency which represents PHC ownership, or stake in the success of the PHC. One example embodiment of a reward selection prompt/display/interface is shown in FIG. 7. Subsequent to the loyalty platform prompting the PHC to select an asset to use in the new rewards program, method 300D may then proceed to 304D.

At 304D, method 300D includes evaluating if the PHC has selected an asset to reward with in the new rewards program. If at 304D, the loyalty platform determines that no asset has been selected, method 300D may proceed to 306D, whereat method 300D includes the loyalty platform evaluating if the PHC has selected to submit a new coin application to create a new crypto asset which suits the goals of the PHC. If at 306D it is determined that the PHC has selected to submit a new coin application, method 300D proceeds to 309, wherein the new coin application submission method is executed. If at 306D, it is determined that the PHC has not selected to submit a new coin application, method 300D may include the loyalty platform returning to the merchant account interface, and method 300D may then end.

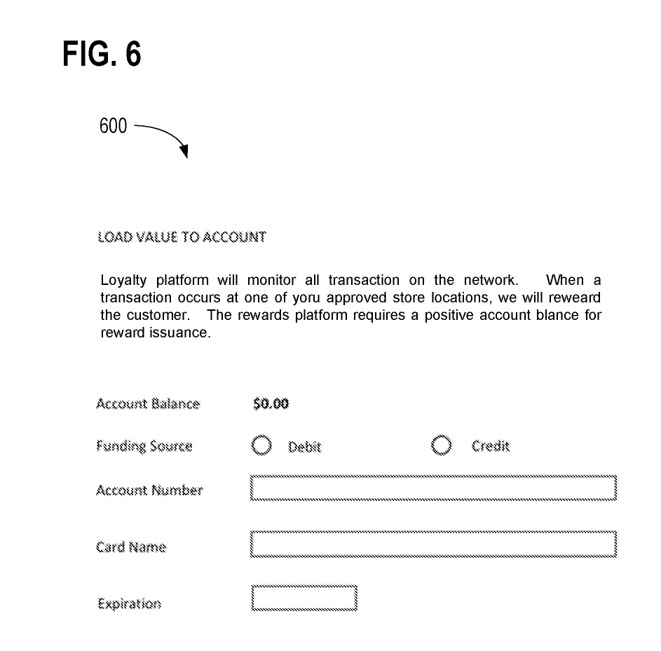

Going back to 304D, if the loyalty platform determines that the PHC has selected a pre-existing asset, either a traditional equity asset or a crypto asset, than method 300D may proceed to 310D, whereat the loyalty platform displays a prompt for new rewards program rules. Along with said prompt, the display/interface may include one or more fields in which the PHC may input said rewards program rules. In one example, rewards program rules may include the rate of reward, such as selection of a percent of each loyalty user purchase which is used to reward said loyalty user. An example of an interface of the rewards program which may take rewards program rules input is shown in FIG. 7, which shows by example, a rewards rate of 4% selected, with indications of the deflation mechanism/LocalCoin fee (0.25%) and the loyalty platform fee (0.25%). In other examples, valid rewards program rules may include parameters relating to an echelon based rewards system, which entitles loyalty users to a higher rate of reward based upon cumulative purchases at rewarding PHC, or other such rules which may relate to one or more aspects of the reward rate, reward type (asset type), reward program duration, or reward program eligibility. From 310D, method 300D may then proceed to 312D, at which PHC input reward program rules may be validated by the loyalty platform, either automatically, or manually by a loyalty platform administrator. If invalid rewards program rules have been input, method 300D may proceed to 314D, whereat an error message is displayed to the PHC, which may indicate the reason for the determination of invalidity of rewards program rules made at 312D. Method 300D may then proceed to display the merchant account interface to the PHC, and method 300D may then end. However, if at 312D, it is determined that valid rewards program rules were input, method 300D may then proceed to 318D, whereat the loyalty platform may prompt the PHC to load value into a rewards fund for the current rewards program using the payment method previously established during initial account creation. An example of such a prompt/interface/display is shown in FIG. 6. Subsequent to prompting the PHC to load value into a rewards program fund, method 300D may then proceed to 320D.

At 320D, method 300D may include determining if assets have been successfully loaded into a rewards program fund. If at 320D it is determined that assets have not been successfully loaded into a rewards program fund, than method 300D may proceed to 322D, whereat an error message may be displayed to the PHC indicating incomplete or unsuccessful transferring of funds. Additionally, the error message may include one or more details relating to the reason for fund transfer failure, or invalid data input. Method 300D may then end.

However, if at 320D, the loyalty platform determines that value has been successfully loaded into a rewards program fund, method 300D may then proceed to 326D, whereat the loyalty platform may prompt the PHC to conduct purchase tracking module calibration, and thereby increase the accuracy with which user purchases made at PHC locations are successfully identified and linked with the rewards program of the PHC, and thus made eligible for reward allocation. Method 300D may then proceed to 328D, whereat it is determined if the PHC has selected to conduct purchase tracking module calibration. If at 328D, the loyalty platform determines that the PHC has selected to conduct purchase tracking module calibration, method 300D may then proceed to 329, wherein the purchase tracking module calibration method is executed. However, if at 328D, the loyalty platform determines that the PHC has selected not to conduct purchase tracking module calibration, method 300D may proceed to 330D, which may include the loyalty platform indicating via display to the PHC that a new rewards program has successfully been created. 330D may further including displaying to the PHC that purchase tracking module calibration may be conducted at any time through the merchant account interface. Method 300D may then proceed to 332D, whereat the loyalty platform displays the merchant account interface. Method 300D may then end.

In this way, method 300D enables a PHC to create equity, or equity-like, rewards programs which foster long term user loyalty and align user and PHC interests though providing rewards, such as equity or equity-like crypto assets, to users based on a loyalty selection by said user, and further based on tracked purchases made by the user at the PHC.

Turning now to FIG. 3E, an example method 300E by which a PHC may submit a new coin application to a crypto asset manager, and based upon said application the crypto asset manager may conduct an initial coin offering (herein abbreviated ICO), to create a new crypto asset which may enable long term user loyalty to institutions or PHCs associated with said crypto asset.

Method 300E begins at 302E, which includes submission of a new coin application to the crypto asset manager via a loyalty platform merchant account interface. In one example, the new coin application includes a model for a new crypto asset, which may be considered analogous to a “white paper”, detailing such aspects of the new crypto asset as: which PHCs or institutions may be associated with said crypto asset (for example, only local business which provide tea or coffee as a primary source of income and are not publicly traded), how said crypto asset may be used (what utility the asset has, or what rights or privileges possessing the asset entails), and/or what deflation mechanisms, if any, operate on the crypto asset to link it to PHC success/revenue (such as a security backing deflation mechanism which increases the value of the crypto asset over time based on PHC revenue, or a buy-back-and-burn deflation mechanism wherein a portion of PHC profits are used to reduce the total supply of the crypto asset over time). Method 300E may then proceed to 304E.

At 304E, method 300E includes the crypto asset manager reviewing the new coin application, and assessing the likelihood of ICO success for such a crypto asset. In one example the review process may occur based on a set schedule, such as 2 weeks after submission of a new coin application. Following completion of review of the new coin application, method 300E may then proceed to 306E.

At 306E, method 300E includes evaluating if the new coin application was approved by the crypto asset manager. If the new coin application was not approved, than method 300E may proceed to 318E, whereat the applicant (the applying PHC) may be notified of rejection of the submitted new coin application, and additionally, may be prompted to make amendments or resubmit the application following such amendments as appropriate. Method 300E may then end.

If at 306E the new coin application was approved by the crypto asset manager, method 300E may then proceed to 308E, whereat the applicant PHC may be notified of the approval of the submitted new coin application, and informed of next steps to be taken by the crypto asset manager and/or given a tentative timeline for when the ICO will be conducted, and potentially when the new crypto asset may be available on the open market (and thus useable in a rewards program). Method 300E may then proceed to 310E.

At 310E, method 300E includes the crypto asset manager or other loyalty platform affiliated entity initiating and conducting an ICO for the new crypto asset. The ICO may comprise any of the steps or processes known in the art for obtaining initial investment for a new crypto asset. Briefly, older or more established digital assets are transferred to a digital wallet of the crypto asset manager, in exchange for issuance and transfer of the new crypto asset to the digital wallets of the investing parties. In one example, the rate of exchange between the older crypto assets (such as Bitcoin, Ethereum, Litecoin, etc.) for the new crypto asset may be fixed. In another example this exchange rate may scale based on the number of investors, amount of investment, time till ICO closes, round of investment (in the case that the ICO has multiple rounds of investment), etc. Allocation of older crypto assets or other funds obtained by the crypto asset manager during the ICO will be detailed in the new crypto asset whitepaper, which may have been created entirely or in part by the applicant PHC. In one example, a set portion of the fund raised during the ICO may be used to establish and operate the new crypto asset network (miners, or other suitable hardware/infrastructure for maintaining the new crypto asset). In another example, a set amount of the funds raised during the ICO may be allocated to purchase a backing security for the new crypto asset, such as NYSE:GLD, or other traditional security, which may lend stability to the price of the new crypto asset. Holders of the new crypto asset may be entitled to exchange the new crypto asset for the backed security via the crypto asset manager, such as through an account created on a loyalty platform, such as loyalty platform 108. Additionally, the amount of traditional security backing the new crypto asset may increase in time based on revenue at associated PHCs, such as based by allocating a percentage of PHC revenue to purchasing additional backing security, or through allocating a percentage of PHC revenue to buy and remove an amount of the new crypto asset of circulation. Upon completion of the ICO, method 300E may then proceed to 312E.

At 312E, method 300E includes the crypto asset manager evaluating if the ICO was successful. ICO success may be based on the amount of funds generated during the ICO. In one example, ICO success may be determined by an amount of funds raised during the ICO being greater than a pre-determined threshold amount of funds. In another example, ICO success may be determined based on a total percent of the newly issued crypto asset being sold being greater than a pre-determined threshold. Upon determination by the crypto asset manager that the ICO of the new crypto asset was a success, method 300E may then proceed to 314E, whereat the applicant PHC is notified of the success of the ICO, and given a tentative timeline for when the new crypto asset will be available on the open market, and thus usable for rewards programs, method 300E may then end.

Alternatively, if at 312E, the crypto asset manager determines that the ICO was a failure, method 300E may then proceed to 316E, whereat the applicant PHC may be notified of the ICO failure for the new crypto asset. Method 300E may then end.

In this way, method 300E may enable creation of new crypto assets by PHCs or other institutions. Said new crypto assets may provide an alternative to equity rewards, which PHCs may use in conjunction with a rewards program created on, and implemented by, a loyalty platform. By offering crypto assets, which enable a host of features and functionalities which traditional rewards or equity cannot (such as built in deflation mechanisms, automated voting rights on company decisions, etc.), PHCs or other institutions unable to provide traditional equity rewards to users may stand on more equal footing with larger corporations, by increasing immediate and long term user loyalty, and aligning user interests with the interests of the PHC.

One issue encountered with an automated rewards systems which allocate rewards to users based on purchases made at small or privately held companies is the difficulty associated with accurately matching a spend ID with a specific merchant. Often the spend ID/transacting merchant description (the merchant information accessible to the loyalty platform which accompanies a tracked transaction recorded, such as merchant location, business type, etc.) may not include sufficient information to uniquely identify the merchant with which the user purchase was made, and thus a user may not receive accurate rewards (e.g., the user may receive rewards even when making purchases at a company other than the company participating in the rewards program, or may incorrectly be denied rewards because the spend ID/transacting merchant description at one location of a company having multiple locations is substantially different than the spend IDs/transacting merchant descriptions at other locations of the same business). The inventors herein have identified methods to at least partially mitigate these issues, such as, in one example, requesting each participating PHC to calibrate the purchase tracking module according to a method, such as method 300F below.

Turning now to FIG. 3F, an example method 300F for enabling more accurate purchase tracking is shown. Instructions for carrying out method 300F may be stored in non-transitory memory of one or more computer readable memory devices of a loyalty platform, such as loyalty platform 108.

Method 300F begins at 302F, which includes prompting a PHC to select a payment method. Said prompting may include displaying one or more fields into which payment method information may be entered, and/or may include displaying a drop down menu of payment methods previously used on the loyalty platform and stored in memory. In the case of previously stored payment methods, the PHC may select which of said stored payment methods to use for the purchase tracking module calibration process. Method 300F may then proceed to 304F.

At 304F, method 300F includes evaluating if the PHC selected a stored payment method. If the loyalty platform determines that no previously used payment method was selected, the method 300F may then proceed to 306F. At 306F, the loyalty platform may evaluate if the PHC has selected to enter a new payment method. If the loyalty platform determines that the PHC did not select to enter a new payment method, then method 300F may proceed to 308F, which includes the loyalty platform returning to the merchant account interface. Method 300F may then end.

However, if at 306F the loyalty platform determines that the PHC selected to enter a new payment method, method 300F may then proceed to 324F. At step 324F, method 300F includes the loyalty platform prompting the PHC to input details of the new payment method to be used for purchase tracking calibration. Upon indication that the PHC has completed entering details of the new payment method, method 300F may proceed to step 326F. At 326F the loyalty platform may conduct input validation of the new payment method details to ensure that the payment method details match to a real and unique payment account, such as a bank account. If at 326F, the loyalty platform determines that valid payment method details were not entered, method 300F may proceed to 328F, whereat the loyalty platform may display an error message to the PHC. In one example the error message may include details regarding the reason for the determination of invalid payment method details, such that the user may rectify the issue upon a subsequent attempt. Method 300F may then continue to 330F, whereat the loyalty platform may display the merchant account interface, and method 300F may then end.

However, if at 326F the loyalty platform made a determination that the payment method details entered by the PHC are valid, method 300F may proceed to 310F, whereat the loyalty platform may indicate to the PHC that the payment method is now ready for purchase tracking calibration, and purchases may now be made at each participating location of the PHC. Method 300F may then proceed to 312F.

At 312F, method 300F includes displaying a list of recent purchases made via the selected payment method. Step 312F further includes prompting the PHC to select each of the purchase IDs/transacting merchant descriptions listed which were made at a PHC location participating in one or more rewards programs. In one example, each transaction ID/transacting merchant description may have a check box associated with it, such that the user may “check” each of the transaction IDs/transacting merchant descriptions associated with a purchase made at a PHC location. In another example, each PHC location may be uniquely associated with a purchase ID. Method 300F may then proceed to 314F.

At 314F, method 300F includes determining if at least one transaction ID/transacting merchant description was associated with at least one PHC location. If no transactions IDs/transacting merchant descriptions were associated with PHC locations, method 300F may proceed to 316F which includes loyalty platform displaying an error message indicating to the PHC that at least one transaction ID/transacting merchant description and one PHC location should be associated in order to enable purchase tracking calibration. Method 300F may then proceed to 318F, whereat the loyalty platform may return to the merchant account interface, and method 300F may then end.

However, if at 314F, the loyalty platform determines that at least on purchase ID/transacting merchant description and one PHC location have been associated, method 300F may then proceed to 320F. At 320F method 300F includes displaying the PHC location(s) successfully associated with the rewards program. Purchases made at these locations may now be more accurately tracked/linked to the PHC and thus associated with rewards programs offered by said PHC, as each participating PHC location is now mapped to a purchase ID/transacting merchant description, thus increasing the accuracy of reward purchase tracking and reward allocation based on user spends at these locations. Method 300F may then proceed to 322F, whereat the loyalty platform may return to the merchant account interface. Method 300F may then end.

In this way, method 300F enables PHCs or other companies to calibrate purchase tracking by creating a map between merchant locations and spend IDs/transacting merchant descriptions, thus enabling the purchase tracking module of the loyalty platform to more accurately identify purchases made by users at these PHCs.

Turning now to FIGS. 4A, 4B, and 4C, an exemplary flowchart illustrating methods 400A, 400B, and 400C is shown. Methods 400A, 400B, and 400C are transaction process methods of the computer-based rewards program, executed by the loyalty platform 108. In this and other examples, “loyalty” or “loyalty selection” may be a selection of a first business in a market made by a user entitling the user to certain privileges including, but not limited to, equity rewards, discounts, special offers, promotions, and others. Making a “loyalty” selection entitles the user to the receipt of privileges from the first business of the market to which loyalty has been selected, but may preclude, or exclude, the user from receiving privileges from a second business, or other companies, in the market. In some examples, a user may be presented with a “loyalty-switch offer” which may be an offer for other privileges provided by a second business in the market, based upon a forfeit of loyalty and privileges to the first business and a selection of loyalty to the second business in the market.

Beginning with 402A, a purchase tracking module (e.g., purchase tracking module 122 of FIG. 1B) of a loyalty platform may receive an indication, or notification, that a user (for example, user 102, 116, 118 of FIG. 1B) has made a purchase or executed a transaction, comprising a dollar amount, with a business (for example, PHCs 138, 140, 106 of FIG. 1B), hereinafter referred to as the “transacting merchant”. As described further, herein, the purchase tracking module may be configured to link to credit cards, debit cards, or any other trackable transaction medium, and when the link is completed, the purchase tracking module may receive all purchase notifications made with that trackable transaction medium. As an example, the transacting merchant may be listed within markets (e.g., markets 156 of FIG. 1B). At 404A the purchase tracking module may track and identify the business and the user involved in the transaction. As an example relating to FIG. 4A, a user may make a purchase with the use of a credit card, tracked by purchase tracking module, at a business. Moving to 406A, purchasing module may then execute a user loyalty lookup, comprising looking up the user's loyalties stored in user accounts (e.g., user accounts 114 of FIG. 1B) at user loyalties (e.g., user loyalties 126 of FIG. 1B). Proceeding to 408A, the method determines if the user is loyal to any business in the market. If the user loyalty lookup returns that the user is loyal to a business or merchant or brand in the market, then the method proceeds to 401 of FIG. 4B, which will be explained in more detail below. As a further example, the user loyalty lookup may be executed by the purchase tracking module.

If the user loyalty lookup determines the user is not loyal to any business in the market, the method proceeds to 410A, where the purchase tracking module requests, or queries, a loyalty manager (e.g., loyalty manager 110 of FIG. 1B) for available or offered user equity rewards with the transacting merchant. Additionally, at 410A, the loyalty manager may provide an option for the user to select loyalty in the market to the transacting merchant. The option provided by loyalty manager may include information regarding loyalty policies (e.g., loyalty policies 142 of FIG. 1B) relating to the transacting merchant. The option provided by loyalty manager may, in an example, include notifications of the rewards available to the user if the user selects the option for the user to select loyalty in the market to the transacting merchant.

Proceeding to 412A, method 400A determines if the user has switched loyalty to the transacting merchant. If the user does select the loyalty-switch offer, the method may proceed to 416A, wherein the user may earn the loyalty-switch offer. Additionally, as an example, the loyalty manager module may update the user's loyalties at user loyalties of user accounts, and the rewards manager (e.g., rewards manager 112 of FIG. 1B) may update the user's current assets (e.g., assets 130 of FIG. 1B) of user accounts. Furthermore, if the user accepts the loyalty-switch offer, the method may proceed to 403 of FIG. 4C. If the user does not select the loyalty-switch offer, the method may proceed to 414A wherein the user earns no equity rewards, privileges, or any other rewards which may comprise selecting the loyalty-switch offer and selecting loyalty to the transacting merchant.

Continuing now with FIG. 4B, at 402B method 400B includes determining if the user has made a loyalty selection to the transacting merchant. Determining if the user made a loyalty selection to the transacting merchant may include looking up the user's loyalties stored in user accounts at user loyalties via the purchasing module executing the user loyalty lookup. If the user loyalty lookup returns that the user is loyal to the transacting merchant, and is therefore intended to receive a reward according to the loyalty policies set forth, the method may proceed to 403 of FIG. 4C, explained in more detail below. If the lookup at step 402B determines that the user is not loyal to the transacting merchant, method 400B may then proceed to 404B where the loyalty manager may present the user with a loyalty-switch offer which may include an option for the user to select a loyalty to the transacting merchant and terminate previously-selected loyalty to another business in the market. As an example, the terms and policies of a loyalty-switch offer may be stored within loyalty policies. In some examples, loyalty-switch offers may include whole or fractional amounts of equity or crypto assets. In some examples, loyalty-switch offers may include equity, or equity-like, rewards offered on transactions and/or discounts on transactions. In an example, loyalty-switch offers may be temporary or permanent or may be based upon any user behavior as defined by the business responsible for the loyalty-switch offer and/or the platform. In an example, loyalty-switch offers may include temporarily higher or increased equity rewards for transactions executed with the transacting merchant.

Additionally, loyalty-switch offers may be presented, offered, or made available to the user at any time, for example, when the user is browsing through available loyalty selections, or as another example, at any desirable time when a user is interacting with the loyalty platform. In an example, a user who is conducting a transaction with a business, with which the user has not selected loyalty (for a given market), may receive a notification, for example via the purchase tracking module or the loyalty manager. The purchase tracking module or loyalty manager may inform the user that equity rewards may not be rewarded for the current transaction based on current loyalty selections. In some cases if the user is merely present within, at, or near a business the user is not loyal to, the notification may further include a loyalty-switch offer so that the user may begin to earn rewards and/or privileges associated with the transacting merchant.

After presenting the loyalty-switch offer to the user, at 406B, the method 400B continues where the purchase tracking module queries the loyalty manager and/or user loyalties to determine if the user has switched loyalty to the transacting merchant. If the user does not switch loyalty to the transacting merchant and declines the loyalty-switch offer, the method 400B may proceed to 408B where the user earns no equity rewards for the transaction. Contrastingly, if the user does switch loyalty to the transacting merchant, the method 400B may proceed to 410B where the loyalty manager may update the user's loyalties at user loyalties of user accounts. The method may further include the rewards manager updating the user's rewards (e.g., rewards 128 of FIG. 1B) of user account (e.g., user account 175 of FIG. 1B) to include the privileges and/or benefits of the loyalty-switch offer. After the user account (for example, user account 175) has been updated, the method 400B may then proceed to 403 of FIG. 4C. As an example, if a user has selected loyalty to a first business but then selects loyalty to a second business via a loyalty-switch offer, the purchase tracking module may update user loyalties to include information that the user has now canceled loyalty or loyalty selection to the first business and selected loyalty to the second business.

Turning now to FIG. 4C, at 402C of method 400C, the purchase tracking module may have tracked a purchase between a user and a business with which the user has made a loyalty selection. As such, the loyalty platform may distribute a reward to the user account associated with the user via a reward allocation system, such as reward allocation system 120 of FIG. 1B, based upon the user rewards of the user account.

In an example, a reward, which may comprise equity, or equity-like crypto assets, may be stored at assets, in user accounts. The example set forth above and herein may provide incentive for users to repeatedly shop (or increase number of transactions) and spend more money at companies which they have selected loyalty to as they may receive rewards, in some cases equity rewards, or equity-like crypto assets. In such an example, users may exhibit increased loyalty to stores or PHCs where they receive rewards.

At 406C, the purchase tracking module may charge a transacting merchant a cumulative rewards charge wherein the cumulative rewards charge includes the value of the reward and a service charge. As an example, a service charge may be a fee charged by a loyalty platform (such as loyalty platform 108 of FIG. 1B) for brokering the equity or equity-like reward, and the service charge may be a percentage of the total transaction dollar amount or it may be a flat dollar fee. In another example, the service charge may further include fees used for the creation, maintenance, or deflation mechanisms of, equity-like crypto assets, and as such a portion, or all, of the service charge may be allocated to the a crypto asset manager, such as crypto asset manager 180 of FIG. 1B. In another example, the cumulative rewards charge may be transferred from a rewards program fund previously loaded with value by the rewarding business, such as reward funds 198 of FIG. 1B.

At 408C, the purchase tracking module may request the reward allocation system to issue a buy order with an equity clearing system (e.g., equity clearing system 104 of FIG. 1B), or crypto asset clearing system (e.g., crypto asset clearing system 105 of FIG. 1B), for equity or crypto asset proportional to the amount of the reward. Once the equity clearing system, or the crypto asset clearing system, settles the transaction, at step 410C, an assign module (e.g., assign module 148 of FIG. 1B) of the reward allocation system may update the user asset to include the assigned reward, and method 400C may end.

In some examples, the method may include determining a reward based upon any one or any combination of: the loyalty selection, and a transaction history of the user. If the user has made a loyalty selection to the transacting merchant, then the user may receive a reward.

Furthermore, based upon the loyalty policy (e.g., stored in loyalty policies 142 of FIG. 1B) of the transacting merchant, the reward may be modified based upon a transaction history of transactions (e.g., transactions 132 of FIG. 1B) made by the user and/or the reward may be modified based upon a method of a user payment (e.g., user payment 134 of FIG. 1B). For example, if a user meets certain criteria based upon past transaction history with the transacting merchant, then the user may receive a modified award. Furthermore, as an example if a user increases their spending, e.g., the frequency of transactions and/or amount of money spent per transaction, the user may receive a greater reward. Furthermore, as an example, if a user decreases his or her spending, the user may receive a lesser reward. In some examples, a modified reward may comprise a modified equity, or equity-like, reward percentage wherein the percentage of the transaction monetary value put towards equity rewards is modified based upon transaction history and/or loyalty history. In some examples, a modified reward may comprise an equity, or equity-like, reward percentage, as disclosed above, as well as a set amount of equity (either fractional or whole shares). As an example, rules and/or instructions for modifying rewards based upon transaction history or user behavior or user history, as mentioned above, may be included in reward policies.

As a further example, if a user uses a particular credit card or particular payment method, which may be promoted or preferred with respect to the transacting merchant, then the user may receive a modified reward based upon a modification policy, wherein the modification policy applies a reward modifier to the reward based upon the payment method used for the transaction.

Turning to FIGS. 5-8 now, representations of exemplary graphical user interfaces (GUI) which may be displayed on a device of a user are shown. As an example, FIGS. 5-8 are shown as GUIs displayed on a mobile phone, however, the GUIs may be adapted to any computing device, mobile or stationary, interactive TV, heads-up display, virtual or augmented reality, or any other display comprising a user input functionality. In an example, the computing device of the user for viewing and operation of GUIs of FIGS. 5-8 may be connected to the Internet. For simplicity, FIGS. 5-8 may be discussed collectively.

As an example, with respect to any and all figures described, when notifications, alerts, loyalty-switch offers, or otherwise are mentioned to be “displayed” or provided to the user, it may be understood that any notifications, alerts, loyalty-switch offers, or otherwise are sent from a computing device to be displayed or provided via a mobile phone, desktop computer, laptop, personal computer and/or computing device of any kind and may be displayed via a display.

FIG. 5 is an example graphical interface including a graphical user interface (GUI) 500 for PHC input of new merchant account information. GUI 500 may be included as part of a method for merchant account creation, such as in method 300B at step 302B of FIG. 3B. GUI 500 may comprise one or more fields for input of merchant account information, such as addresses of store locations, address of business headquarters, business type (markets in which the business operates), and business contact information (such as email, phone number, etc.). Additionally, GUI 500 may include one or more messages or written instructions to the PHC, for clarification of required input, which may be displayed to the PHC via the display device. Data input into one or more of the fields may occur via an input device, such as a touch screen of a smartphone, a keypad, a keyboard, a mouse, or other hardware devices suitable for converting user gestures or motions into data for storage in one or more computer memory devices of loyalty platform 108.

Turning now to FIG. 6, an example graphical interface is shown, including a graphical user interface (GUI) 600 for PHC input of payment method information. GUI 600 may be displayed on a PHC display device by a loyalty platform, such as loyalty platform 108 of FIG. 1B, as part of a method for new rewards program creation, such as method 300D at step 318D of FIG. 3D. GUI 600 may comprise one or more fields for input of payment method information, such debit card numbers, credit card numbers, bank account information, digital wallet address and key, or any other information associated with a payment account or payment service by which the PHC may load funds into a newly created rewards program. GUI 600 may further include one or more fields wherein the PHC may specify an amount of value to load into a rewards program using the payment method. Data input into one or more of said fields may occur via a input device, such as a touch screen of a smartphone, a keypad, a keyboard, a mouse, or other hardware devices suitable for converting gestures or motions into data for storage in one or more computer memory devices of loyalty platform 108. Payment method information entered into a GUI, such as GUI 600, may be stored on memory of the loyalty platform, and such a stored payment method may be selected for future purchases made on the loyalty platform without the PHC reentering the payment method details.

FIG. 7 is an example graphical interface including a graphical user interface (GUI) 700 for PHCs or other companies to select an asset with which to reward loyalty users. GUI 700 may be included as part of rewards program creation, such as in method 300D at step 302D and/or 310D of FIG. 3D. GUI 700 may display selectable reward assets, such as equities or crypto assets, and the selectable assets may be organized by type (U.S. securities or crypto assets), associated companies (all assets related to a certain market or industry), or may be searchable using a search field. The assets with which a given PHC or other business may choose to reward their users may be based on information provided during loyalty platform account creation, and as such, the selectable assets on GUI 700 may be based on this information. Additionally, GUI 700 may include details regarding selectable assets which may facilitate asset selection by the PHC or other business. In one example, crypto assets may include information regarding the deflation mechanism of said asset, the PHCs associated with the crypto asset, and the criterion specifying which companies or PHCs may reward using the crypto asset. Additionally, GUI 700 may include one or more fields for selecting the rate (flat or percent of purchase) with which loyalty users are rewarded. In some examples the rate of rewards is a fixed percentage of the loyalty user purchase amount (monetary amount). In another example, the reward rate may be based on a loyalty history, or transaction history, of the loyalty user, such as a rate schedule which gives a higher rate of reward to users with a consistent history of spending at the rewarding business. GUI 700 may further include a cumulative fee breakdown, showing the total fee charged per transaction (either as a flat amount or as a percent of the transaction total), and the allocation of the cumulative fee. Data input into one or more of said fields may occur via an input device, such as a touch screen of a smartphone, a keypad, a keyboard, a mouse, or other hardware devices suitable for converting gestures or motions into data for storage in one or more computer memory devices of loyalty platform 108 of FIG. 1B.

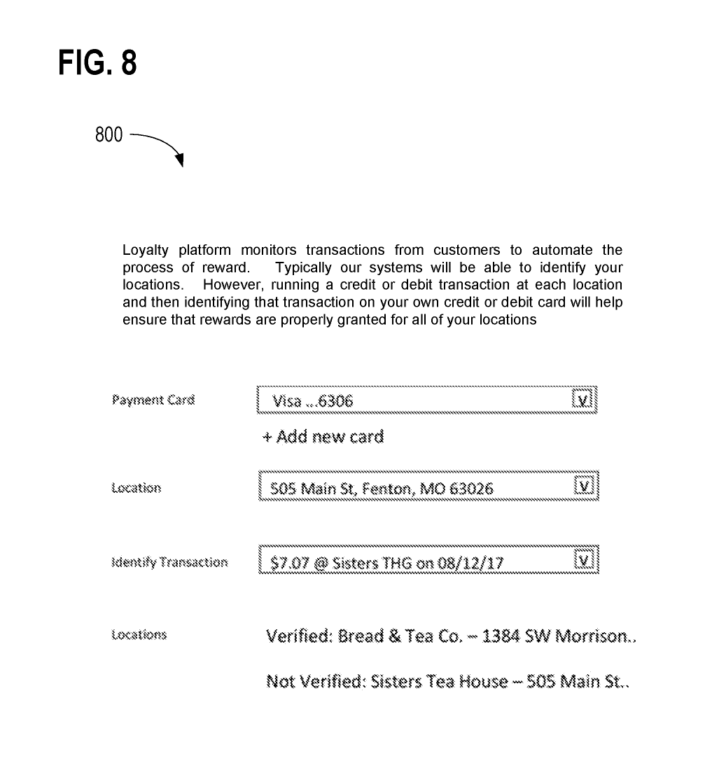

Turning now to FIG. 8, an example graphical interface including a graphical user interface (GUI) 800 for calibrating purchase tracking is shown. GUI 800 may be included as part of a method for purchase tracking calibration, such as in method 300F at step 302F and 312F of FIG. 3E. GUI 800 may comprise one or more fields for input of payment method information, spend IDs (history of tracked purchases) on said payment method, and business location at which an associated spend occurred. Additionally, GUI 800 may include one or more messages or written instructions to the PHC, for clarification of required input, which may be displayed to the PHC via the display device. In one example, selecting a previously registered payment method causes a history of tracked purchases made with the payment method to be displayed on GUI 800, such as via a pulldown menu, wherein the transactions may be selectable. In another example, business locations may be displayed, and selectable, such that business locations previously input and stored in computer readable memory of a loyalty platform, such as during merchant account creation as at step 302B of method 300B of FIG. 3B, may be displayed to the PHC along with an indication of the purchase tracking calibration status of that business location (such as verified or unverified). In another example, by selecting a business location and a tracked purchase made using the payment method at that business location, a purchase tracking system or module, such as purchase tracking module 122 of FIG. 1B, may associate the selected purchase (including the spend ID) with the selected business location. Associating/linking spend IDs with specific business locations in this way enables more accurate mapping of spends to business locations, which in turn enables more accurate rewards distribution to users. Data input into one or more of said fields may occur via an input device, such as a touch screen of a smartphone, a keypad, a keyboard, a mouse, or other hardware devices suitable for converting gestures or motions into data for storage in one or more computer memory devices of loyalty platform 108.

Turning now to FIG. 9, an illustrative diagram showing an example process 900 of how a crypto asset manager, such as crypto asset manager 180 of FIG. 1B, may create a new crypto asset through an ICO, such as may occur in method 300E at step 310E of FIG. 3E. Process 900 includes allocating 50% of the revenue made from the ICO to initiate the deflation mechanism of the crypto asset, which is an asset backing mechanism in this case, by buying an amount of a traditional security for which the newly issued crypto asset may be exchanged, such as on crypto asset/backed security exchange 182 hosted by the crypto asset manager. Process 900 further includes allocating 50% of the funds raised via the ICO to the crypto asset manager. In one example, ICO funds allocated to the crypto asset manager are used to develop the network (nodes, miners, etc.) required for implementation of a crypto asset. In other examples, ICO funds allocated to the crypto asset manager may be used to market the new crypto asset, or to cover costs associated with conducting an ICO. Process 900 further illustrates that newly issued crypto asset is distributed to ICO investors following successful completion of the ICO. Following crypto asset distribution, the newly issued crypto asset may be listed on crypto asset exchanges, such as crypto asset clearing system 105.

Turning now to FIG. 10, an illustration of an example process 1000 is shown. Process 1000 illustrates how PHCs may increase user demand by providing equity-like rewards via a loyalty platform.

Turning to FIG. 11, an example transaction model 1100 of a crypto asset is shown in diagram. Transaction model 1100 illustrates one example of how a crypto asset, used as part of a rewards program, may increase in value based on transactions made at rewarding business or PHCs (a rewarding business or PHC is herein defined to mean a business or other entity, registered with a loyalty platform, and actively conducting a rewards program through the loyalty platform). In transaction model 1100, a portion of each loyalty transaction goes to the crypto asset manager to implement the deflation mechanism associated with the given crypto asset. Thus, as the number of loyalty transactions increase, the amount of money allocated to the deflation mechanism of the crypto asset increases (thereby increasing its value). This is one example by which a crypto asset may be tied or linked to the revenue or success of a company, which may be especially advantageous in cases where the company is not publicly traded and thus may particularly benefit from creation of an equity-like asset. The crypto asset manager may use these funds to implement the deflation mechanism detailed in the whitepaper of the crypto asset. In one example, the deflation mechanism includes the crypto asset manager buying a portion of a backing security for the crypto asset. The backing security preferably being a security with low price volatility. In another example, the deflation mechanism includes the crypto asset manager buying an amount of the crypto asset at market price, and burning said amount (immutably removing said amount from circulation), thereby reducing the total supply of the crypto asset and increasing the value of the remaining crypto asset.

In one example, a method of providing an equity-like reward with a loyalty platform includes receiving an indication of a user purchase at a selected company, based on a relationship defined for the user and the selected company, receiving a request to issue a reward to the user for the user purchase, and, responsive to receiving the request, determining a success-linked crypto asset for the user based on one or more characteristics of the transaction, the user, and/or the selected company. The method may further include issuing the determined success-linked crypto asset to an account associated with the user, and triggering display, on a user computing device of an indication of the success-linked crypto asset. In a first example of the method, an amount of the determined success-linked crypto asset may additionally or alternatively be based on one or more of a purchase amount for the transaction, rules of a rewards program as established by the selected company, and loyalties selected by the user. A second example of the method optionally includes the first example, and further includes the method, wherein a value of the determined success-linked crypto asset is based on a revenue generated by the selected company. A third example of the method optionally includes one or both of the first example and the second example, and further includes the method, wherein the success-linked crypto asset includes a commodity or security backing the success-linked crypto asset. A fourth example of the method optionally includes one or more of the first through the third examples, and further includes the method, wherein issuing the success-linked crypto asset to the account includes generating an updated account total that includes the success-linked crypto asset and updating the account to reflect the updated account total. A fifth example of the method optionally includes one or more of the first through the fourth examples, and further includes the method, wherein the transaction is a first transaction, the method further comprising receiving an indication of a second transaction in which the user requests to use at least a portion of assets in the account toward a purchase amount associated with the second transaction, determining a value of the assets in the account based on an amount of success-linked crypto assets in the account and a revenue of the selected company at a time of the second transaction, and withdrawing a number of the success-linked crypto assets based on the purchase amount and the determined value of the success-linked crypto assets. In this way, the method has a technical effect of increasing an efficiency of the asset management system using a single asset (the success-linked crypto asset) to respond to both user transactions and company performance (e.g., revenue).

In another example, a method of grouping companies for providing success-linked rewards with a crypto asset management system, the method including receiving selection from a user indicating loyalty to a selected company, the selected company being included in a rewards program group of privately-held companies, receiving an indication of a transaction performed by a user at the selected company, based on a relationship defined for the user and the rewards program group, receiving a request to issue a reward to the user for performing the transaction, responsive to receiving the request, determining a success-linked crypto asset for the user based on one or more characteristics of the transaction, the user, and/or the rewards program group, issuing the determined success-linked crypto asset to an account associated with the user, the success-linked crypto asset having a value that is based on revenue generated by members of the rewards program group, triggering display, on a display device associated with the user, of an indication of the success-linked crypto asset. In a first example of the method, the method may additionally or alternatively further include monitoring, with the crypto asset management system, a value of the account based on changes in the revenue generated by the members of the rewards program group. A second example of the method optionally includes the first example, and further includes the method, wherein an amount of the determined success-linked crypto asset is based on one or more of a purchase amount for the transaction, rules of a rewards program as established by the selected company, and loyalties selected by the user. In this way, the method has a technical effect of increasing an efficiency of an asset management system by combining rewards programs for multiple companies (e.g., based on a class or other grouping feature for the companies and a loyalty selection from a user).

In another example, a method includes receiving a loyalty selection from a user, the loyalty selection comprising a selection of a privately held company listed in a database of a loyalty platform in order to receive a success-linked crypto asset associated with the selected privately held company, matching a user purchase with the privately held company by correlating details of the user purchase with the database of the loyalty platform using a calibrated purchase tracking module, determining an amount of success-linked crypto assets based on a monetary value of the user purchase, a user transaction history, and one or more reward policies, distributing the amount of success-linked crypto asset to a user account of the user, and displaying the amount of success-linked crypto asset distributed to the user account. In a first example of the method, the loyalty selection may additionally or alternatively comprise an exclusionary selection of the privately held company in a market of the loyalty platform. A second example of the method optionally includes the first example, and further includes the method, wherein displaying the amount of success-linked crypto asset includes rendering the amount of success-linked crypto asset in a user interface of a user computing device. A third example of the method optionally includes the first example and/or the second example, and further includes the method, wherein a deflation mechanism of the success-linked crypto asset is operated based on revenue of the privately held company. A fourth example of the method optionally includes the first example, the second example, and/or the third example, and further includes the method, wherein operation of the deflation mechanism comprises buying an amount of a security to back the success-linked crypto asset, wherein the amount of the security is proportional to the revenue of the privately held company. A fifth example of the method optionally includes the first, second, third, and/or fourth examples, and further includes the method, wherein operation of the deflation mechanism comprises buying a portion of the success-linked crypto asset and immutably removing the portion of the success-linked crypto asset from circulation, wherein the portion is proportional to the revenue of the privately held company. A sixth example of the method optionally includes the first, second, third, fourth, and/or fifth examples, and further includes the method, wherein matching the user purchase with the privately held company by correlating purchase details with the database of the loyalty platform using the calibrated purchase tracking module comprises the loyalty platform tracking purchases made with a linked payment medium used to conduct the user purchase. A seventh example of the method optionally includes the first, second, third, fourth, fifth, and/or sixth examples, and further includes the method, wherein the linked payment medium comprises one of a debit card, a credit card, and a virtual wallet. An eighth example of the method optionally includes the first, second, third, fourth, fifth, sixth, and/or seventh examples, and further includes the method, further comprising, prompting the user to make the loyalty selection to the privately held company based on the user being within a threshold distance of the privately held company. A ninth example of the method optionally includes the first, second, third, fourth, fifth, sixth, seventh, and/or eighth examples, and further includes the method, further comprising determining the amount of the success-linked crypto asset as a percentage of a monetary value of the user purchase. A tenth example of the method optionally includes the first, second, third, fourth, fifth, sixth, seventh, eighth, and/or ninth examples, and further includes the method, further comprising issuing a buy order to a crypto asset clearing system for the amount of the success-linked crypto asset.

Another example provides for a method of providing a success-linked crypto asset reward using a loyalty platform, the method including receiving an indication of a user purchase performed at a privately held company, based on a user loyalty selection to the privately held company and further based on one or more characteristics of the transaction, determining an amount of a success-linked crypto asset reward, issuing the determined amount of the success-linked crypto asset to an account associated with the user, and triggering display, on a display device associated with the user, of an indication of the success-linked crypto asset. In a first example of the method, the determined amount of the success-linked crypto asset may additionally or alternatively be based on a purchase amount for the transaction, rules of a rewards program as established by the privately held company, and/or a purchase history of the user. A second example of the method optionally includes the first example, and further includes the method, wherein the determined amount of the success-linked crypto asset is based on a payment medium used to conduct the user purchase. A third example of the method optionally includes one or both of the first example and the second example, and further includes the method, wherein the success-linked crypto asset includes a commodity or security backing the success-linked crypto asset. A fourth example of the method optionally includes the first example, the second example, and/or the third example, and further includes the method, wherein issuing the determined amount of the success-linked crypto asset to an account includes generating an updated account total that includes the amount of the success-linked crypto asset and updating the account to reflect the updated account total.

Another example provides for a computing system implementing a loyalty platform, the computing system including a processor, and a non-transitory memory storing instructions executable by the processor to receive a loyalty selection from a user computing device, the loyalty selection comprising a selection of a privately held company listed in a database of a loyalty platform to receive a success-linked crypto asset associated with the privately held company, match a user purchase with the privately held company by correlating a transacting business description associated with the purchase with a description of the business stored in the database of the loyalty platform, determine an amount of the success-linked crypto asset based on a monetary value of the user purchase, a user transaction history, and business reward policies, distribute the amount of the success-linked crypto asset to an account of the user, and display the amount of the success-linked crypto asset to the user computing device. In a first example of the computing system, the user purchase may additionally or alternatively include a first purchase, and the non-transitory memory may additionally or alternatively further comprise instructions executable by the processor to receive an indication of a second purchase in which the user requests to use at least a portion of success-linked crypto assets in the account toward a purchase amount associated with the second purchase, determine a value of the success-linked crypto assets in the account, and/or withdraw a portion of the success-linked crypto assets based on the purchase amount and the determined value of the success-linked crypto assets. A second example of the computing system optionally includes the first example, and further includes the computing system, wherein the non-transitory memory further comprises instructions executable by the processor to monitor, with the crypto asset management system, a value of the account based on changes in the revenue of one or more associated privately held companies. A third example of the computing system optionally includes one or both of the first example and the second example, and further includes the computing system, wherein the loyalty selection excludes the user from receiving rewards from unselected businesses.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method comprising:
receiving a loyalty selection from a user, the loyalty selection comprising a selection of a privately held company listed in a database of a loyalty platform in order to receive a success-linked crypto asset associated with the selected privately held company;
matching a user purchase with the privately held company by correlating details of the user purchase with the database of the loyalty platform using a calibrated purchase tracking module;
determining an amount of success-linked crypto assets based on a monetary value of the user purchase, a user transaction history, and one or more reward policies;
distributing the amount of success-linked crypto asset to a user account of the user; and
displaying the amount of success-linked crypto asset distributed to the user account.

2. The method of claim 1, wherein the loyalty selection comprises an exclusionary selection of the privately held company in a market of the loyalty platform.

3. The method of claim 1, wherein displaying the amount of success-linked crypto asset includes rendering the amount of success-linked crypto asset in a user interface of a user computing device.

4. The method of claim 1, wherein a deflation mechanism of the success-linked crypto asset is operated based on revenue of the privately held company.

5. The method of claim 4, wherein operation of the deflation mechanism comprises buying an amount of a security to back the success-linked crypto asset, wherein the amount of the security is proportional to the revenue of the privately held company.

6. The method of claim 4, wherein operation of the deflation mechanism comprises buying a portion of the success-linked crypto asset and immutably removing the portion of the success-linked crypto asset from circulation, wherein the portion is proportional to the revenue of the privately held company.

7. The method of claim 1, wherein matching the user purchase with the privately held company by correlating purchase details with the database of the loyalty platform using the calibrated purchase tracking module comprises the loyalty platform tracking purchases made with a linked payment medium used to conduct the user purchase.

8. The method of claim 7, wherein the linked payment medium comprises one of a debit card, a credit card, and a virtual wallet.

9. The method of claim 1, further comprising, prompting the user to make the loyalty selection to the privately held company based on the user being within a threshold distance of the privately held company.

10. The method of claim 1, further comprising determining the amount of the success-linked crypto asset as a percentage of a monetary value of the user purchase.

11. The method of claim 1, further comprising issuing a buy order to a crypto asset clearing system for the amount of the success-linked crypto asset.

12. A method of providing a success-linked crypto asset reward using a loyalty platform, the method comprising:
receiving an indication of a user purchase performed at a privately held company;
based on a user loyalty selection to the privately held company and further based on one or more characteristics of the transaction, determining an amount of a success-linked crypto asset reward;
issuing the determined amount of the success-linked crypto asset to an account associated with the user; and
triggering display, on a display device associated with the user, of an indication of the success-linked crypto asset.

13. The method of claim 12, wherein the determined amount of the success-linked crypto asset is based on a purchase amount for the transaction, rules of a rewards program as established by the privately held company, and/or a purchase history of the user.

14. The method of claim 12, wherein the determined amount of the success-linked crypto asset is based on a payment medium used to conduct the user purchase.

15. The method of claim 12, wherein the success-linked crypto asset includes a commodity or security backing the success-linked crypto asset.

16. The method of claim 12, wherein issuing the determined amount of the success-linked crypto asset to an account includes generating an updated account total that includes the amount of the success-linked crypto asset and updating the account to reflect the updated account total.

17. A computing system implementing a loyalty platform, comprising:
a processor; and
a non-transitory memory storing instructions executable by the processor to:
receive a loyalty selection from a user computing device, the loyalty selection comprising a selection of a privately held company listed in a database of a loyalty platform to receive a success-linked crypto asset associated with the privately held company;
match a user purchase with the privately held company by correlating a transacting business description associated with the purchase with a description of the business stored in the database of the loyalty platform;
determine an amount of the success-linked crypto asset based on a monetary value of the user purchase, a user transaction history, and business reward policies;
distribute the amount of the success-linked crypto asset to an account of the user; and
display the amount of the success-linked crypto asset to the user computing device.

18. The computing system of claim 17, wherein the user purchase is a first purchase, and the non-transitory memory further comprises instructions executable by the processor to:
receive an indication of a second purchase in which the user requests to use at least a portion of success-linked crypto assets in the account toward a purchase amount associated with the second purchase;
determine a value of the success-linked crypto assets in the account; and
withdraw a portion of the success-linked crypto assets based on the purchase amount and the determined value of the success-linked crypto assets.

19. The computing system of claim 17, wherein the non-transitory memory further comprises instructions executable by the processor to:
monitor, with the crypto asset management system, a value of the account based on changes in the revenue of one or more associated privately held companies.

20. The computing system of claim 17, wherein the loyalty selection excludes the user from receiving rewards from unselected businesses.
